(19) United States
(12) Patent Application Publication
(10) Pub. No.: US 2016/0328138 A1
(43) Pub. Date: Nov. 10, 2016

(54) INPUT DEVICE, SERVER, INPUT PROGRAM, AND INPUT METHOD

(71) Applicant: Panasonic Intellectual Property Management Co., Ltd., Osaka (JP)

(72) Inventors: Hiroki HIGUCHI, Osaka (JP); Koichiro YAMAGUCHI, Osaka (JP)

(21) Appl. No.: 15/213,753

(22) Filed: Jul. 19, 2016

Related U.S. Application Data
(63) Continuation of application No. PCT/JP2015/000172, filed on Jan. 16, 2015.

(30) Foreign Application Priority Data
Mar. 18, 2014 (JP) 2014-054650

(51) Int. Cl. G06F 3/0484; G06Q 30/02; G06F 17/21; G06T 11/60; G06F 3/0482; G06F 17/24

(52) U.S. Cl. CPC G06F 3/04847; G06F 3/0482; G06F 17/24; G06F 17/212; G06T 11/60; G06Q 30/0277

(57) ABSTRACT

Provided is a signage system having a control screen that facilitates update. An input device according to the present disclosure includes: a generator configured to generate a control screen for updating a content; a display unit configured to display the control screen; and an editing unit configured to edit the content using the control screen. Groups containing a plurality of components are defined in the content, and the generator generates group frames respectively for the groups on the control screen, and generates the control screen so that when one of the group frames is selected by the editing unit, the plurality of components contained in corresponding one of the groups are changed at once.

### BACKGROUND

1. Technical Field

The present disclosure relates to an input device, a server, an input program, and an input method which are capable of updating advertising information to be displayed in a display device.

2. Description of Related Art

In recent years, use of digital signage (hereinafter referred to as signage) has been widely spread along with lowering of prices of display devices. Such signage facilitates modification of display contents.

Unexamined Japanese Patent Publication No. 2011-186529 discloses a signage system that records original content file groups grouped based on template code, replacement material file groups, and content file groups respectively for content names, and is capable of modifying a content of signage using the replacement material file groups.

### SUMMARY

The present disclosure provides an input device that generates a control screen facilitating update by grouping components contained in a signage content into groups of contents for respective commercial products or the like.

The input device according to the present disclosure includes: a generator configured to generate a control screen for updating a content; a display unit configured to display the control screen; and an editing unit configured to edit the content using the control screen, wherein groups containing a plurality of components are defined in the content, and the generator generates group frames respectively for the groups on the control screen, and generates the control screen so as to change together the plurality of components contained in one of the groups, when one of the group frames is selected by the editing unit.

The input device according to the present disclosure generates a control screen by grouping components contained in a signage content into groups of contents for respective commercial products or the like, and thus facilitates updating of signage content by a user.

### BRIEF DESCRIPTION OF DRAWINGS

FIG. 1 is a block diagram illustrating a signage system according to a first exemplary embodiment.

FIG. 2 is a diagram illustrating one example of a signage content according to the first exemplary embodiment.

FIG. 3 is a diagram illustrating one example of a template for the signage content according to the first exemplary embodiment.

FIG. 4 is a diagram illustrating a relation between the template in FIG. 3 and signage contents.

FIG. 5 is a diagram illustrating grouping of components in the signage content in FIG. 2.

FIG. 6 is a diagram illustrating a description example of the signage content in FIG. 5.

FIG. 7 is a detailed block diagram of the signage system according to the first exemplary embodiment.

FIG. 8 is a diagram illustrating one example of a control screen for the signage content in FIG. 2 displayed in a display unit of an input device according to the first exemplary embodiment.

FIG. 9 is a diagram illustrating one of group frames displayed in a signage content area on the control screen in FIG. 8.

FIG. 10 is a diagram illustrating a control screen when a position within a group frame in the signage content area on the control screen in FIG. 8 is pressed.

FIG. 11 is a diagram illustrating a control screen when a content of the group frame on the control screen in FIG. 10 is changed and previewed.

FIG. 12 is a flowchart for update of a signage content in the input device according to the first exemplary embodiment.

FIG. 13 is a detailed flowchart for S1201 in FIG. 12.

FIG. 14 is a detailed flowchart for S1202 in FIG. 12.

FIG. 15 is a detailed flowchart for S1203 in FIG. 12.

FIG. 16 is a detailed flowchart for S1204 in FIG. 12.

FIG. 17 is a flowchart for update of a signage content in a server according to the first exemplary embodiment.

FIG. 18 is a diagram illustrating another example of the signage content according to the first exemplary embodiment.

FIG. 19 is a diagram illustrating another example of the template for the signage content according to the first exemplary embodiment.

FIG. 20 is a diagram illustrating grouping of components in the signage content in FIG. 18.

FIG. 21 is a diagram illustrating one example of a control screen for the signage content in FIG. 18 displayed in the display unit of the input device according to the first exemplary embodiment.

FIG. 22 is a diagram illustrating a control screen when a position within a group frame in a signage content display area on the control screen in FIG. 21 is pressed.

FIG. 23 is a diagram illustrating a control screen when a next button in a text update area and a next button in an image update area on the control screen in FIG. 22 are pressed.

FIG. 24A is a diagram illustrating one example of a plurality of group frames of the signage content.

FIG. 24B is a diagram illustrating one example of positions of the plurality of group frames in FIG. 24A on the control screen.

FIG. 24C is a diagram illustrating selection of the group frames at overlapping positions in FIG. 24B where the plurality of group frames overlap.

FIG. 25A is a diagram illustrating another example of a plurality of group frames of the signage content.

FIG. 25B is a diagram illustrating one example of positions of the plurality of group frames in FIG. 25A on the control screen.

FIG. 25C is a diagram illustrating selection of the group frames at overlapping positions in FIG. 25B where the plurality of group frames overlap.

FIG. 26 is a diagram illustrating further another example of the signage content according to the first exemplary embodiment.

FIG. 27 is a diagram illustrating further another example of the template for the signage content according to the first exemplary embodiment.

FIG. 28 is a diagram illustrating groups in the signage content in FIG. 26.

FIG. 29 is a diagram illustrating one example of a control screen for the signage content in FIG. 26 displayed in the display unit of the input device according to the first exemplary embodiment.

FIG. 30 is a diagram illustrating a control screen when playback in a signage content display area on the control screen in FIG. 29 is started and then posed.

FIG. 31 is a diagram illustrating a control screen when a position within a group frame in a signage content display area on the control screen in FIG. 30 is pressed.

FIG. 32 is a diagram illustrating a control screen when playback of a signage content display area on the control screen in FIG. 31 is started, and then the signage content is updated.

FIG. 33 is a detailed block diagram of the signage system according to a second exemplary embodiment.

FIG. 34 is a diagram illustrating one example of a control screen for the signage content in FIG. 18 displayed in a display unit of an input device according to the second exemplary embodiment.

FIG. 35 is a diagram illustrating another example of a control screen for the signage content in FIG. 18 displayed in the display unit of the input device according to the second exemplary embodiment.

### DESCRIPTION OF EMBODIMENTS

Hereinafter, exemplary embodiments will be described in detail with reference to the drawings as appropriate. However, excessively detailed descriptions may be omitted. For example, detailed descriptions for well-known matters or repeating descriptions for components that are substantially the same may be omitted if appropriate. This is for the purpose of preventing the following description from becoming excessively redundant, and of facilitating understanding of a person skilled in the art.

It should be understood that the attached drawings and the following description are provided so that a person skilled in the art may fully understand the present disclosure, and are not intended to limit the subject matters recited in the claims in any way.

Hereinafter, exemplary embodiments according to the present disclosure will be described with reference to the drawings.

### First Exemplary Embodiment

### 1-1. Overview of Signage System

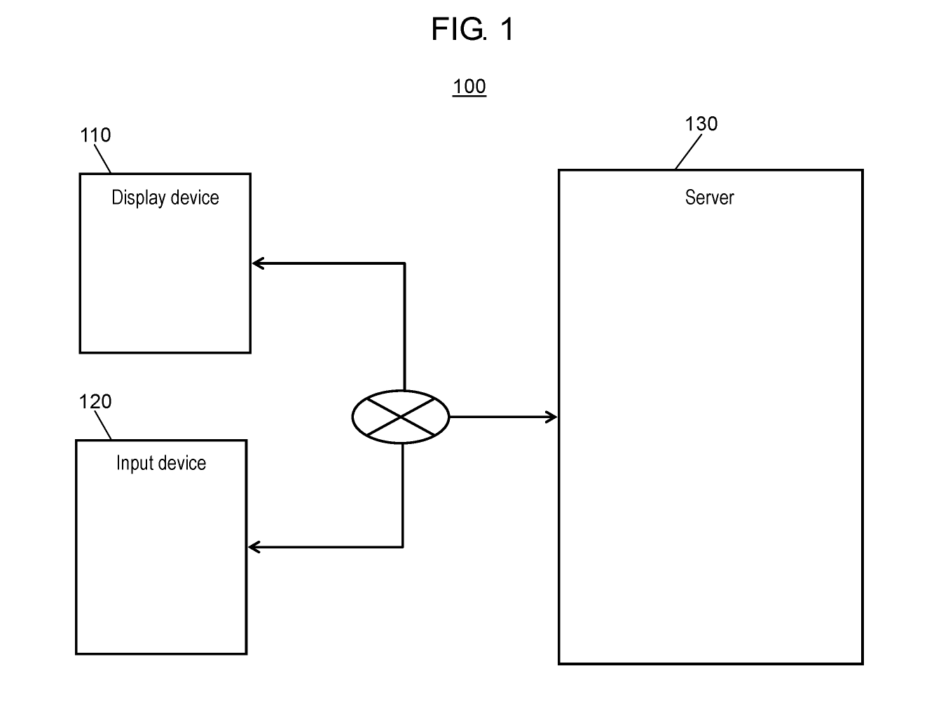

FIG. 1 is a block diagram illustrating a signage system according to one exemplary embodiment.

Signage system 100 is configured by display device 110, input device 120, and server 130. Display device 110 displays a signage content. Input device 120 inputs an update content of the signage content. Server 130 manages the signage content. Display device 110 and server 130, and input device 120 and server 130 are connected via a network, respectively. Communication between display device 110 and server 130, and communication between input device 120 and server 130 may employ a secure communication system to prevent spoofing and such. Further, communication between input device 120 and server 130 may be authenticated using a terminal ID (IDentification) for identifying input device 120 or a user ID for identifying a user such as an employee.

Examples of display device 110 include a large display of 60 inches or greater placed in the front of a store. Examples of input device 120 include a PC (Personal Computer) or a smartphone operated by an employee or the like of the store where display device 110 is placed.

Server 130 records a signage content. Upon reception of an update request for this signage content from input device 120, server 130 transmits this signage content to input device 120. Upon reception of an update content from input device 120, server 130 updates this signage content that has been recorded, and transmits the updated signage content to input device 120. Further, upon reception of a display request for this signage content from display device 110, server 130 transmits this signage content to display device 110.

Input device 120 transmits an update request for a signage content to server 130. Then, input device 120 receives the signage content for which update is requested from server 130. Input device 120 generates a control screen based on the received signage content, and display the generated control screen. Input device 120 edits the signage content through the displayed control screen, and transmits a content updated by the editing to server 130.

Display device 110 transmits a display request for a signage content to server 130. Display device 110 receives the signage content for which display is requested from server 130, and displays the received signage content.

### 1-2. Signage Content (1)

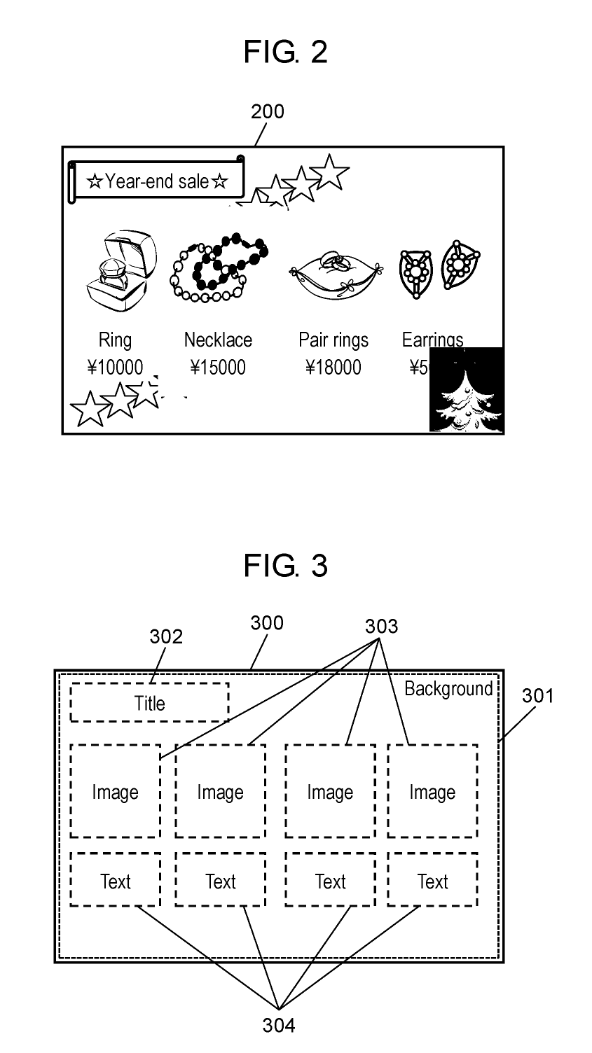

Next, the signage content will be described in detail. FIG. 2 is a diagram illustrating one example of the signage content according to the first exemplary embodiment. With reference to FIG. 2, signage content 200 is a signage content for a jewelry store, and stars and a tree for Christmas are designed on a background. A message “Year-End Sale” is shown at an upper left position. In a center, four sets of an image, a commercial product name, and a price of jewelry are shown. Signage content 200 is generated based on a previously prepared template.

FIG. 3 is a diagram illustrating one example of the template for the signage content according to the first exemplary embodiment. With reference to FIG. 3, template 300 contains components including background 301, title 302, images 303, and texts 304. Each of the components defines a display area, a data format, and the like of the component when displayed in display device 110. A background design may be provided on background 301. As title 302, a title and a title design of the signage such as “Year-End Sale” or “Today's Special” may be disposed. As images 303, image data of the commercial products may be disposed. As texts 304, names and prices of the commercial products may be disposed.

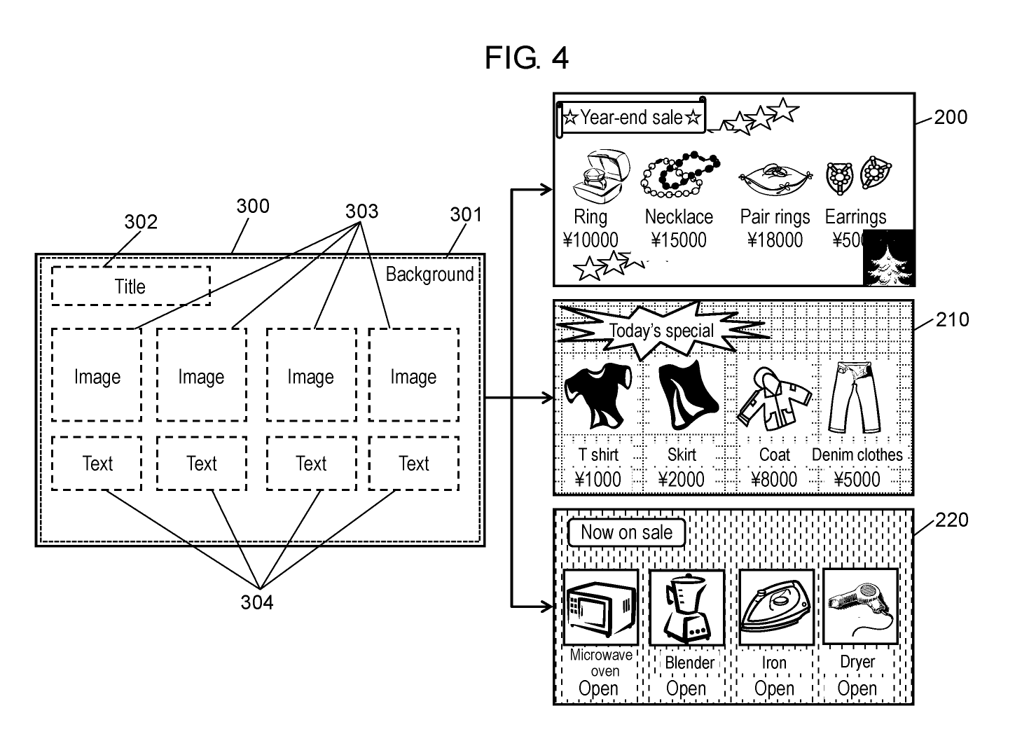

FIG. 4 is a diagram illustrating a relation between template 300 in FIG. 3 and signage contents. As illustrated in FIG. 4, server 130 uses template 300 to generate signage content 200 for a jewelry store described with reference to FIG. 3. Server 130 may further generate signage content 210 for an apparel store and signage content 220 for an appliance store using template 300.

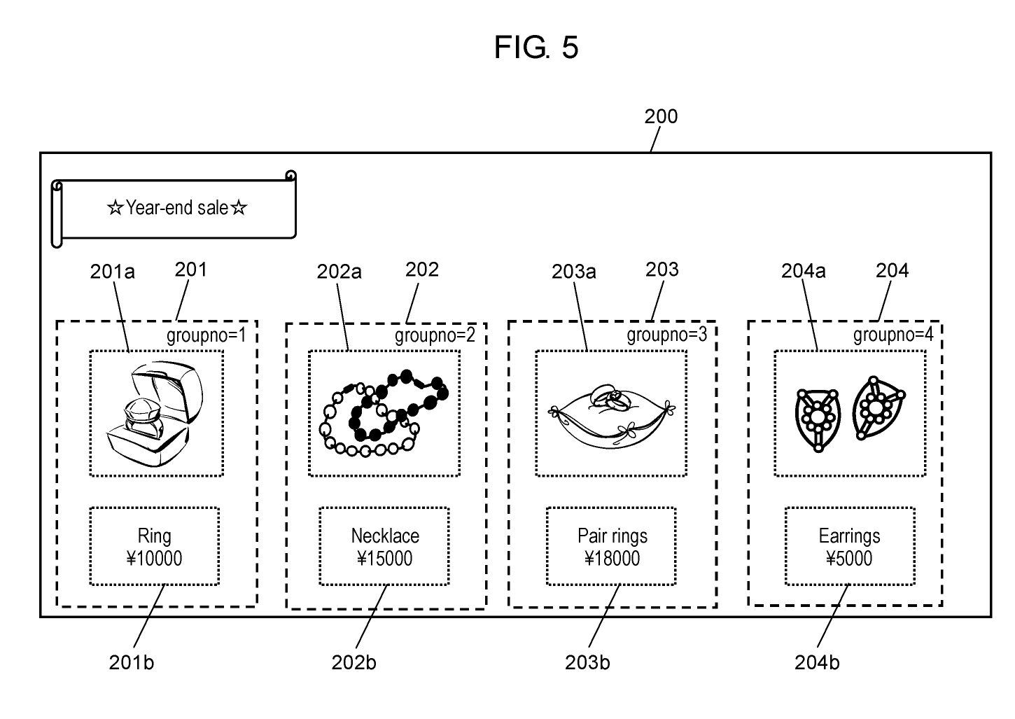

Components contained in signage content 200 are grouped. FIG. 5 is a diagram illustrating grouping of the components in signage content 200 for a jewelry store in FIG. 2. With reference to FIG. 5, images 303 and texts 304 in template 300 in FIG. 2 are grouped for each commercial product. Specifically, signage content 200 contains groups 201, 202, 203, 204. Group 201 contains image 201a and text 201b, and is represented by group number (groupno) 1. Group 202 contains image 202a and text 202b, and is represented by group number 2. Group 203 contains image 203a and text 203b, and is represented by group number 3. Group 204 contains image 204a and text 204b, and is represented by group number 4. Groups 201, 202, 203, 204 are a unit for updating signage content 200. The groups are set so that image 202a and text 202b are changed at the same time when the commercial product for group 202 is to be changed, for example.

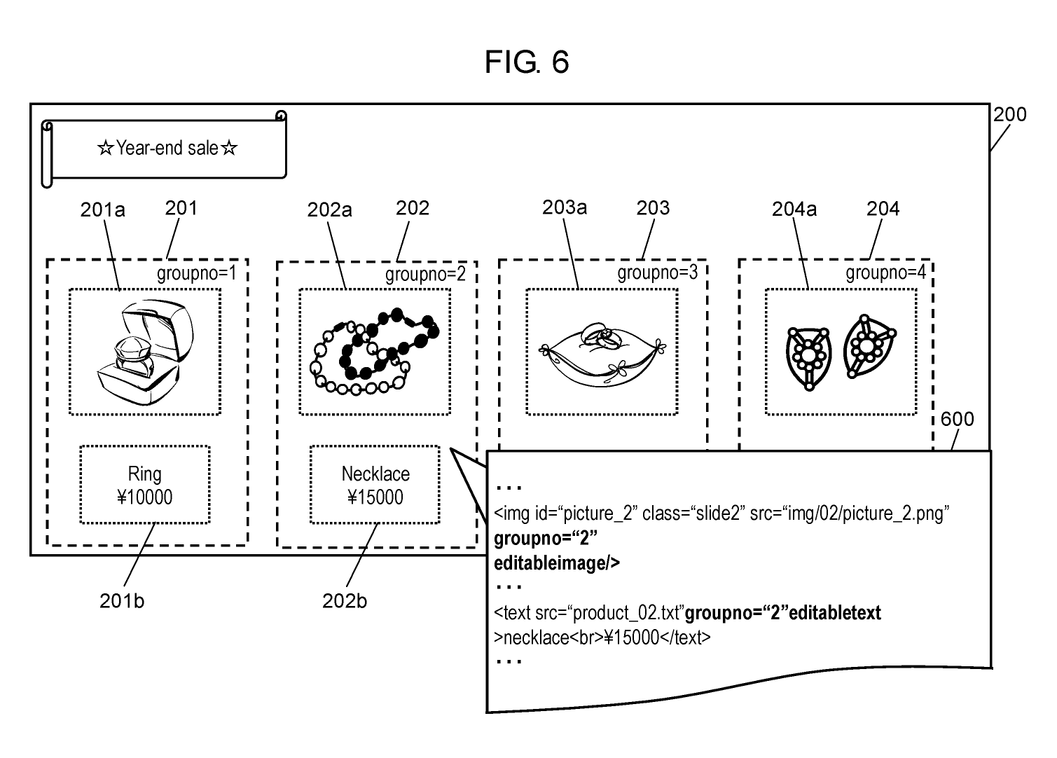

FIG. 6 is a diagram illustrating a description example in a recording format of signage content 200 in FIG. 5. Signage content 200 is described in a format such as HTML (HyperText Markup Language) format or XML (Extensible Markup Language) format, for example. In FIG. 6, a description for group 202 is shown as file 600. In addition to a basic description for image 202a and text 202b, “groupno=2” and “editableimage” are added as a description for a tag attribute for image 202a, and “groupno=2” and “editabletext” are added as a description for a tag attribute for text 202b. This indicates that image 202a and text 202b belong to the same group, which is identified group number 2. Further, “editableimage” and “editabletext” indicate that the corresponding components may be updated.

### 1-3. Configuration of Signage System

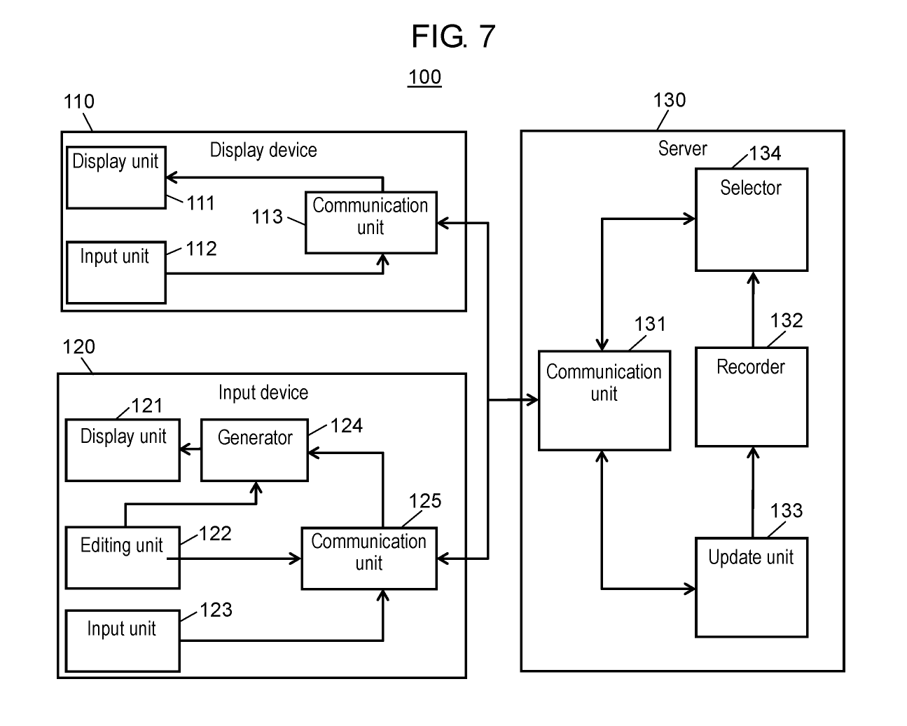

Next, a configuration of the signage system will be described in detail. FIG. 7 is a detailed block diagram of signage system 100 according to the first exemplary embodiment.

Display device 110 includes display unit 111, input unit 112, and communication unit 113. Input device 120 includes display unit 121, editing unit 122, input unit 123, generator 124, and communication unit 125. Server 130 includes communication unit 131, recorder 132, update unit 133, and selector 134.

On a side of display device 110, a display request for a signage content is input through input unit 112. Input unit 112 supplies this display request to communication unit 113. Upon reception of the display request, communication unit 113 transmits the display request to communication unit 131 of server 130. Upon reception of the signage content that is requested for display from communication unit 131 of server 130, communication unit 113 supplies the received signage content to display unit 111. Display unit 111 that has received the signage content displays the signage content.

Display unit 111 is realized, for example, by a display such as a liquid crystal display (LCD), and a processor for executing a predetermined process. Input unit 112 is realized, for example, by an input device such as a touch panel, a keyboard, or a pointing device such as a mouse, a joystick, or a touch pad, and a processor for executing a predetermined process. Communication unit 113 is realized by a wireless or wired communicating device, and a processor for executing a predetermined process.

On a side of input device 120, an update request for a signage content is input through input unit 123. Input unit 123 supplies this update request to communication unit 125. Upon reception of the update request, communication unit 125 transmits the update request to communication unit 131 of server 130. Upon reception of the signage content for which update is requested from communication unit 131 of server 130, communication unit 125 supplies the received signage content to generator 124. Generator 124 that has received the signage content generates a control screen based on the signage content, and supplies the generated control screen to display unit 121. Display unit 121 displays the supplied control screen. A user of input device 120 edits the signage content to which updating is desired using the control screen displayed in display unit 121 through editing unit 122. At this time, editing unit 122 supplies the content to be updated by editing to communication unit 125. Communication unit 125 to which the update content is supplied transmits the updated content to communication unit 131 of server 130. Upon reception of the updated signage content from the communication unit 131 of server 130, communication unit 125 supplies the updated signage content to generator 124. Generator 124 that has received the signage content generates a control screen based on the signage content, and supplies the generated control screen to display unit 121. Display unit 121 displays the supplied control screen.

Display unit 121 is realized, for example, by a display such as a liquid crystal display, and a processor for executing a predetermined process. Editing unit 122 is realized, for example, by an input device such as a touch panel, a keyboard, or a pointing device such as a mouse, a joystick, or a touch pad, and a processor for executing a predetermined process. Input unit 123 is realized, for example, by an input device such as a touch panel, a keyboard, or a pointing device such as a mouse, a joystick, or a touch pad, and a processor for executing a predetermined process. Generator 124 is realized by a processor for executing a predetermined process. Communication unit 125 is realized by a wireless or wired communicating device, and a processor for executing a predetermined process.

On a side of server 130, recorder 132 records signage contents. Upon reception of a display request from communication unit 113 of display device 110, communication unit 131 supplies the display request to selector 134. Selector 134 that has received the display request reads a signage content corresponding to the display request from recorder 132, and supplies the read signage content to communication unit 131. Communication unit 131 transmits the read signage content to communication unit 113 of display device 110.

In addition, upon reception of an update request from communication unit 125 of input device 120, communication unit 131 supplies the update request to selector 134. Selector 134 reads a signage content corresponding to the update request from recorder 132, and supplies the read signage content to communication unit 131. Communication unit 131 transmits the read signage content to communication unit 125 of input device 120. Then, upon reception of an update content from communication unit 125 of input device 120, communication unit 131 supplies the update content to update unit 133. Update unit 133 that has received the update content updates a signage content corresponding to the update request, and records the updated signage content in recorder 132. Then, update unit 133 supplies the updated signage content to communication unit 131. Communication unit 131 transmits the updated signage content to communication unit 125 of input device 120.

Communication unit 131 is realized by a wireless or wired communicating device, and a processor for executing a predetermined process. Recorder 132 is realized by an optical or magnetic reading recording medium. Update unit 133 and selector 134 are each realized by a processor for executing a predetermined process.

In the above description, starting display of the signage content in display unit 111 on the side of display device 110 is executed by, but not limited to, the display request from input unit 112 of display device 110. Information on playback schedule of the signage content may be stored in recorder 132 of server 130, the signage content is read from recorder 132 and transmitted to display device 110 automatically based on the schedule to start display of the signage content in display unit 111.

### 1-4. Update of Signage Content

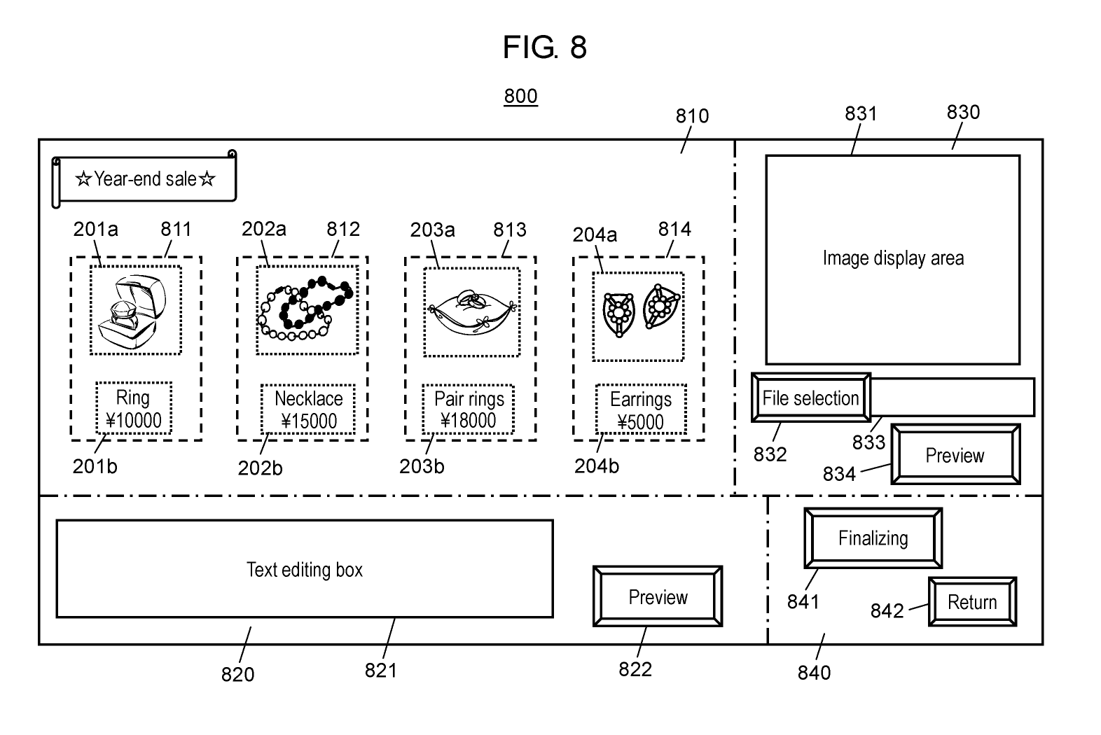

Next, update of the signage content by input device 120 will be described. FIG. 8 is a diagram illustrating one example of a control screen for signage content 200 in FIG. 2 displayed in display unit 121 of input device 120 according to the first exemplary embodiment.

FIG. 8 shows control screen 800 for updating signage content 200 for a jewelry store. With reference to FIG. 8, control screen 800 includes signage content display area 810, text update area 820, image update area 830, and update executing area 840.

In signage content display area 810, a signage content to be updated is displayed. In FIG. 8, signage content 200 in FIG. 2 is displayed. Signage content 200 in signage content display area 810 will be described excluding a background. In signage content display area 810, rectangular frames in dashed lines are shown respectively for groups defined by signage content 200. Specifically, group frame 811 corresponding to group number 1, group frame 812 corresponding to group number 2, group frame 813 corresponding to group number 3, and group frame 814 corresponding to group number 4 are displayed. Selecting any of group frames 811, 812, 813, 814 enables editing of texts and images that belong to a group corresponding to the selected group frame. The texts are edited in text update area 820, and the images are edited in image update area 830.

Text update area 820 is an area for modifying a content of texts 201b, 202b, 203b, 204b in signage content 200. Text update area 820 includes text editing box 821 and preview button 822. Text editing box 821 is a widget for inputting a content to be modified in the text to which the user wishes to change. Preview button 822 is a button widget for showing the content input in text editing box 821 in signage content display area 810 for confirmation.

Image update area 830 is an area for modifying a content of images 201a, 202a, 203a, 204a in signage content 200. Image update area 830 includes image display area 831, file selection button 832, text box 833, and preview button 834. File selection button 832 is a widget for selecting a file by pressing a button, and clicking this button shows a file selection dialogue. Then, by selecting an arbitrary file through the dialogue, a name of the selected file is displayed in text box 833. Text box 833 enables selection of a location at which data for an image desired to be displayed is stored by inputting characters for the location at which data for an image desired to be displayed is stored or by clicking file selection button 832. In image display area 831, an image indicated in text box 833 is displayed. Preview button 834 is a button widget for showing the image indicated in text box 833 in signage content display area 810 for confirmation.

Update executing area 840 is an area for transmitting the content updated in text update area 820 and in image update area 830 to server 130, and for updating signage content 200 recorded in recorder 132 of server 130. Update executing area 840 includes finalizing button 841 and return button 842. By pressing finalizing button 841, the content updated in text update area 820 and image update area 830 is supplied to communication unit 125. By pressing return button 842, an application screen before the display shifts to control screen 800 is resumed.

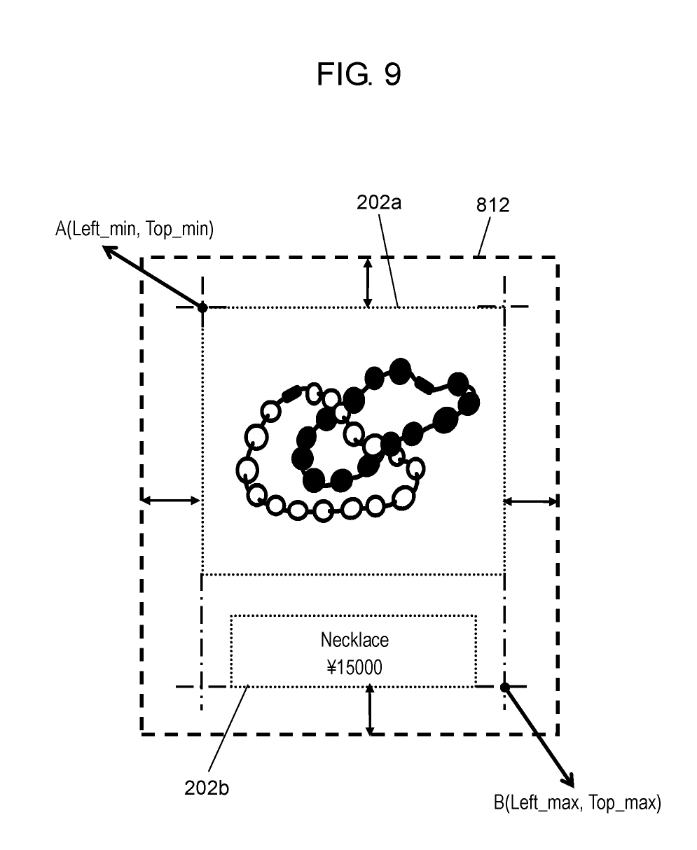

Next, display of group frames 811, 812, 813, 814 in signage content display area 810 will be described. FIG. 9 is a diagram illustrating one of the group frames displayed in signage content display area 810 in control screen 800 in FIG. 8. With reference to FIG. 9, the description is given taking group frame 812 out of the group frames as an example. The description for group frame 812 also applies to group frames 811, 813, 814. With reference to FIG. 9, group frame 812 is a frame for group 202 of group number 2, and includes image 202a and text 202b. Group frame 812 is configured such that when any position within the frame is pressed, it is determined that the group corresponding to group frame 812 is selected, and then image 202a and text 202b that belong to group frame 812 are set as update objects to be updated respectively in text update area 820 and image update area 830. Group frame 812 is also configured such that a color or a type of the line for the frame changes before and after any position within the frame is pressed, for example, the type of the line changes from dashed line to dotted line. Further, group frame 812 is also configured such that the color of the frame changes from a paler color to a darker highlighted color, for example. In FIG. 8, each of group frames 811, 812, 813, 814 is in a black dashed line, and configured such that the line changes to a red solid line when a position within the group frame is pressed, for example.

A displayed position and a size of group frame 812 in signage content display area 810 is determined based on displayed positions and sizes of image 202a and text 202b that belong to group 202. Specifically, in FIG. 9, a coordinate of group frame 812 is determined by setting a blank space to right, left, up and bottom sides from coordinate A (Left_min, Top_min) at an upper left end and coordinate B (Left_max, Top_max) at a lower right end indicating a minimum rectangle containing image 202a and text 202b.

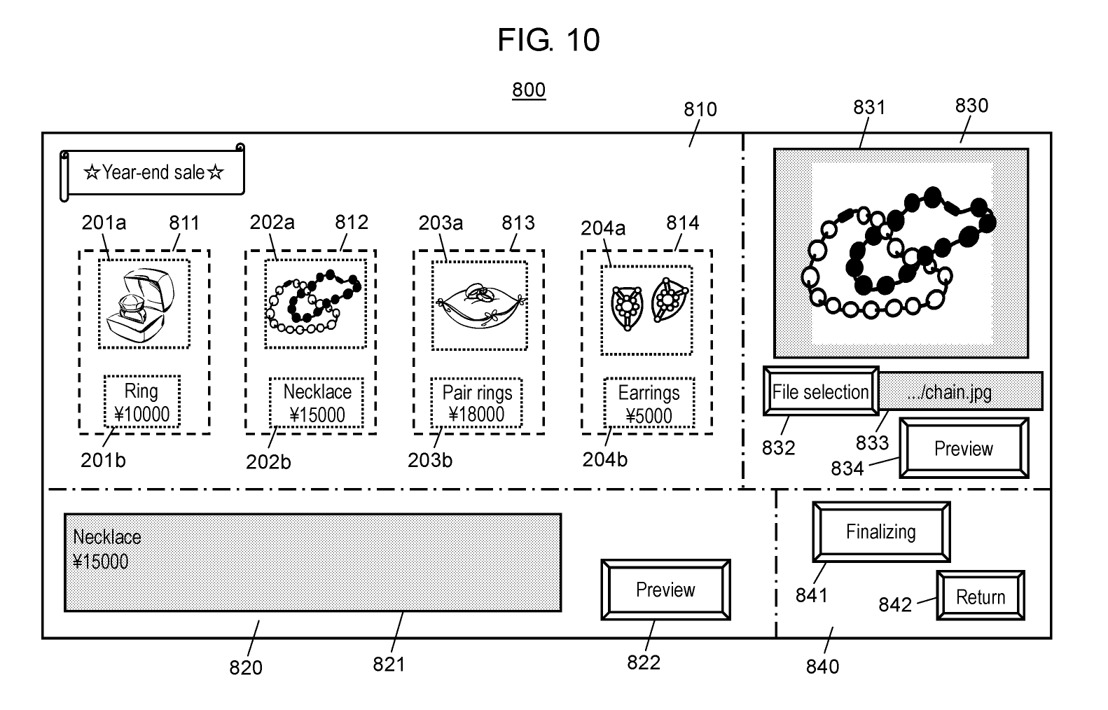

FIG. 10 is a diagram illustrating control screen 800 when a position within group frame 812 in signage content display area 810 in control screen 800 in FIG. 8 is pressed. When the position within group frame 812 is pressed in signage content display area 810 in FIG. 8, representation of group frame 812 changes from a dashed line to a solid line, and from black to red. Further, “necklace” and “¥15000” (15000 yen) as text 202b belonging to the group corresponding to group frame 812 that has been selected are displayed in text editing box 821 in text update area 820. An image for image 202a belonging to the group corresponding to group frame 812 that has been selected is displayed in image display area 831 in image update area 830, and “ . . . /chain.jpg” as a location at which image 202a is temporarily recorded is displayed in text box 833.

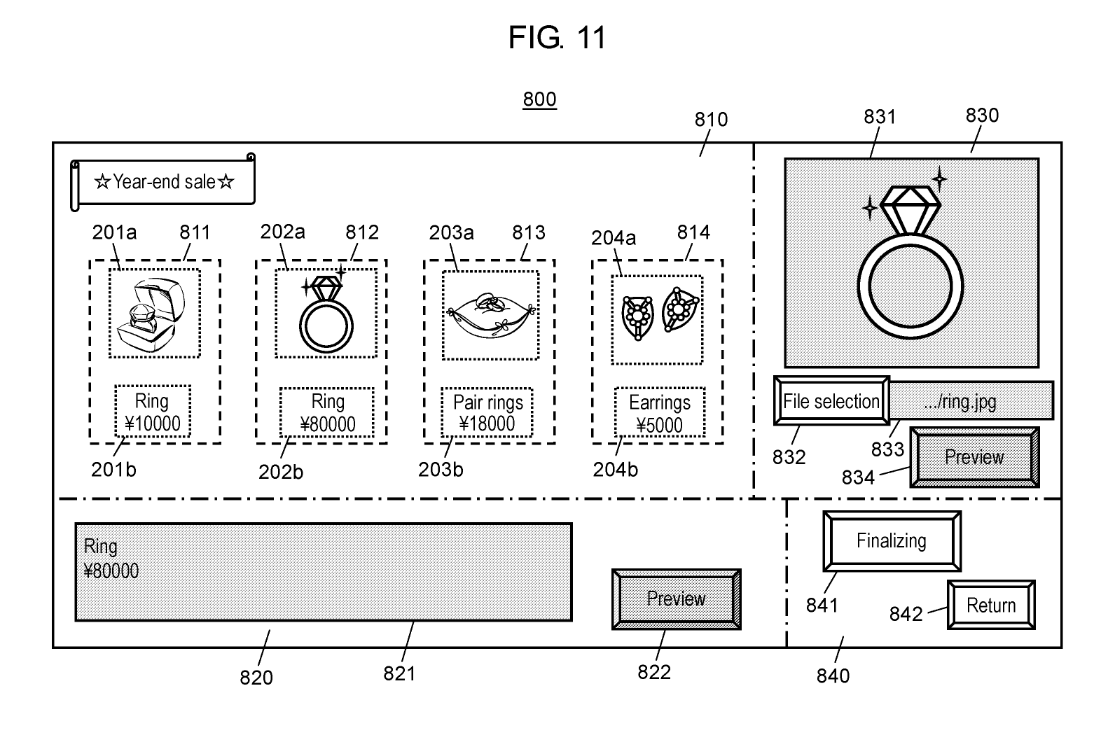

FIG. 11 is a diagram illustrating control screen 800 when a content of group frame 812 in control screen 800 in FIG. 10 is changed and previewed. With reference to FIG. 11, by inputting “ring” and “¥80000” (80000 yen) in text editing box 821 in text update area 820, and pressing preview button 822, a content to be updated of text 202b in group frame 812 in signage content display area 810 may be confirmed. Further, by inputting “ . . . /ring.jpg” in text box 833 in image update area 830 to display an image corresponding to “ . . . /ring.jpg” in image display area 831, and pressing preview button 834, a content to be updated of image 202a in group frame 812 in signage content display area 810 may be confirmed. If the signage content is updated to the content to be updated, finalizing button 841 is pressed.

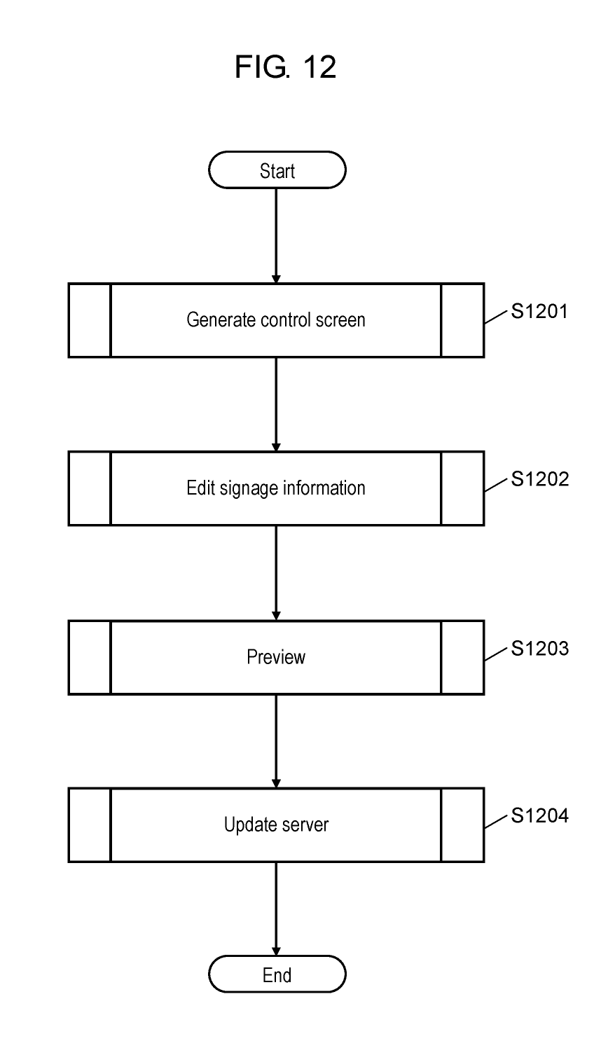

FIG. 12 is a flowchart for update of signage content 200 in input device 120 according to the first exemplary embodiment.

(S1201) A user inputs an update request for signage content 200 through input unit 123 of input device 120. Input unit 123 supplies the update request to communication unit 125. Communication unit 125 that has received the update request transmits the update request to communication unit 131 of server 130. Upon reception of signage content 200 for which update is requested from communication unit 131 of server 130, communication unit 125 supplies signage content 200 to generator 124. Generator 124 that has received signage content 200 generates control screen 800 based on signage content 200, and supplies control screen 800 that has been generated to display unit 121. Display unit 121 displays control screen 800 that has been supplied.

(S1202) The user of input device 120 confirms a content in control screen 800 displayed in display unit 121, and edits a content desired to be updated in signage content 200 through editing unit 122.

(S1203) The content that has been edited through editing unit 122 is previewed by pressing preview button 822 or preview button 834 in control screen 800.

(S1204) Editing unit 122 instructs to edit, and supplies the update content to communication unit 125. Communication unit 125 to which the update content is supplied transmits the update content of signage content 200 to communication unit 131 of server 130. Then, the updated signage content is transmitted to communication unit 125 from communication unit 131 of server 130. From communication unit 125, the updated signage content is supplied to generator 124. Generator 124 generates a control screen for the updated signage content, and supplies the control screen to display unit 121. Display unit 121 displays the supplied control screen.

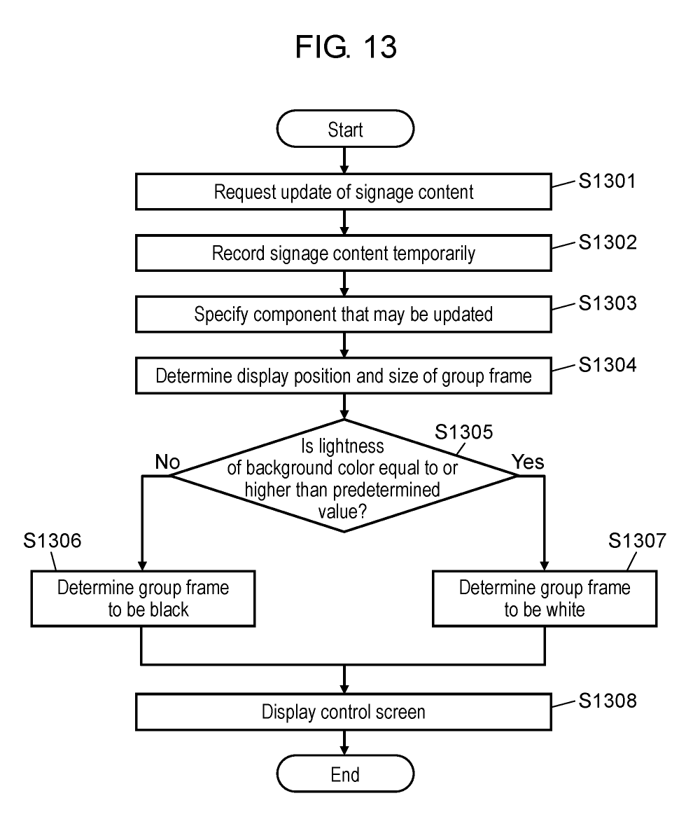

FIG. 13 is a detailed flowchart for S1201 in FIG. 12.

(S1301) The user inputs the update request for signage content 200 through input unit 123 of input device 120. Input unit 123 supplies the update request to communication unit 125. Communication unit 125 that has received the update request transmits the update request to communication unit 131 of server 130. Upon reception of signage content 200 for which update is requested from communication unit 131 of server 130, communication unit 125 supplies signage content 200 to generator 124.

(S1302) Generator 124 that has received signage content 200 temporarily records signage content 200.

(S1303) Generator 124 specifies components that may be updated in signage content 200. Specifically, generator 124 specifies that in signage content 200, image 201a and text 201b belong to the same group represented by group number 1, image 202a and text 202b belong to the same group represented by group number 2, image 203a and text 203b belong to the same group represented by group number 3, image 204a and text 204b belong to the same group represented by group number 4, and all of these components may be updated.

(S1304) Generator 124 determines displayed positions and sizes of group frames 811, 812, 813, 814 respectively based on coordinate values and sizes of components that may be updated.

(S1305) Generator 124 determines whether or not lightness of a background color of signage content 200 is equal to or higher than a predetermined value. The lightness of the background color is determined for each of the group frames. The lightness of the background color is obtained by adding and averaging RGB (Red-Green-Blue color model) values obtained at midpoints of line segments of four sides of a rectangle for each of the group frames, and then compared with a predetermined value. If the lightness of the background color of signage content 200 is lower than the predetermined value (No), the process moves to S1306, and if the lightness of the background color of signage content 200 is equal to or higher than the predetermined value (Yes), the process moves to S1307.

(S1306) If the lightness of the background color of signage content 200 is lower than the predetermined value, the background color is whitish, and thus the color of the group frame to be displayed is determined to be black.

(S1307) If the lightness of the background color of signage content 200 is equal to or lower than the predetermined value, the background color is dark, and thus the color of the group frame to be displayed is determined to be white.

(S1308) Display unit 121 displays control screen 800 as described with reference to FIG. 8.

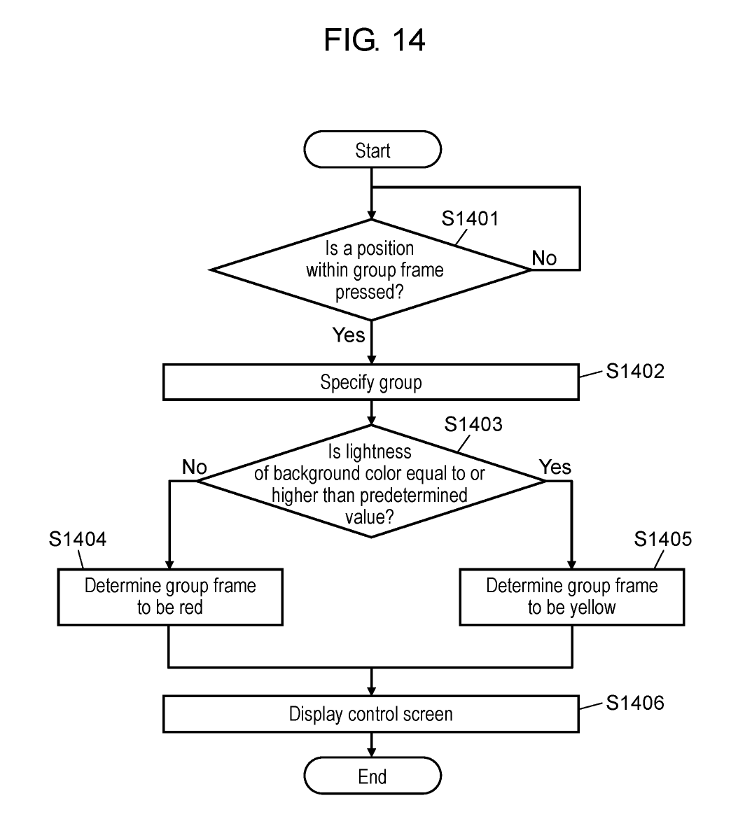

FIG. 14 is a detailed flowchart for S1202 in FIG. 12.

(S1401) Editing unit 122 determines whether or not the group frame in signage content display area 810 in control screen 800 is pressed by the user. If the group frame is pressed (Yes), the process moves to S1402. If the group frame is not pressed (No), the process returns to S1401.

(S1402) Editing unit 122 specifies a group number of the pressed group frame. When group frame 812 is pressed as described with reference to FIG. 10, for example, the group to which image 202a and text 202b belong is determined to be a group of group number 2.

(S1403) Editing unit 122 determines whether or not the lightness of the background color of signage content 200 at a position of group frame 812 is equal to or higher than the predetermined value. The lightness of the background color is obtained by adding and averaging RGB (Red-Green-Blue color model) values obtained at midpoints of line segments of four sides of a rectangle for group frame 812, and then compared with a predetermined value. If the lightness of the background color of signage content 200 is lower than the predetermined value (No), the process moves to S1404, and if the lightness of the background color of signage content 200 is equal to or higher than the predetermined value (Yes), the process moves to S1405.

(S1404) If the lightness of the background color of signage content 200 is lower than the predetermined value, the background color is whitish, and thus the color of the group frame to be displayed is determined to be red.

(S1405) If the lightness of the background color of signage content 200 is equal to or lower than the predetermined value, the background color is dark, and thus the color of the group frame to be displayed is determined to be yellow.

(S1406) Generator 124 sets such that a content of the text contained in the pressed group frame is displayed in text editing box 821, and that a content of the image is displayed in image display area 831 and text box 833, and then generates control screen 800 described with reference to FIG. 10 using the determined color of the group frame. Display unit 121 displays control screen 800 as illustrated in FIG. 10.

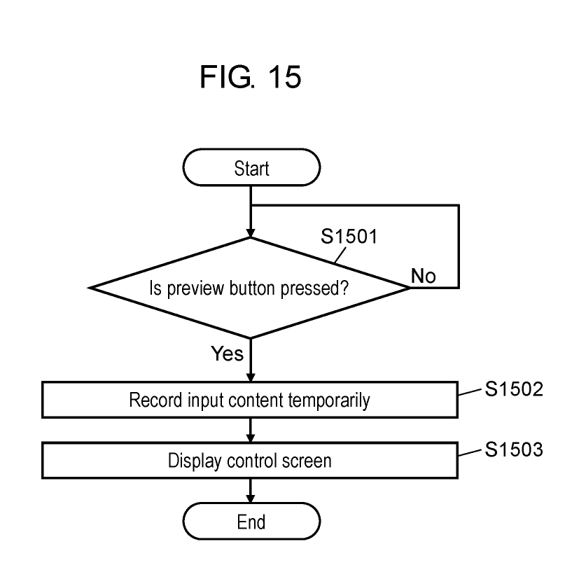

FIG. 15 is a detailed flowchart for S1203 in FIG. 12.

(S1501) After the user completes either editing in text editing box 821 in text update area 820 in control screen 800, or editing in image display area 831 and text box 833 in image update area 830, editing unit 122 determines whether or not the user has pressed preview button 822, 834. If the user has pressed the button (Yes), the process moves to S1502. If the user has not pressed the button (No), the process returns to S1501.

(S1502) If preview button 822 in text update area 820 is determined to have been pressed, editing unit 122 temporarily stores the content of text editing box 821. Further, if preview button 834 in image update area 830 is determined to have been pressed, editing unit 122 temporarily stores image data at a location of the file shown in text box 833, and supplies the image data to generator 124.

(S1503) Generator 124 reflects an update content in text editing box 821 or in image display area 831 in signage content display area 810 in control screen 800 described with reference to FIG. 11, and display unit 121 displays control screen 800 in FIG. 11.

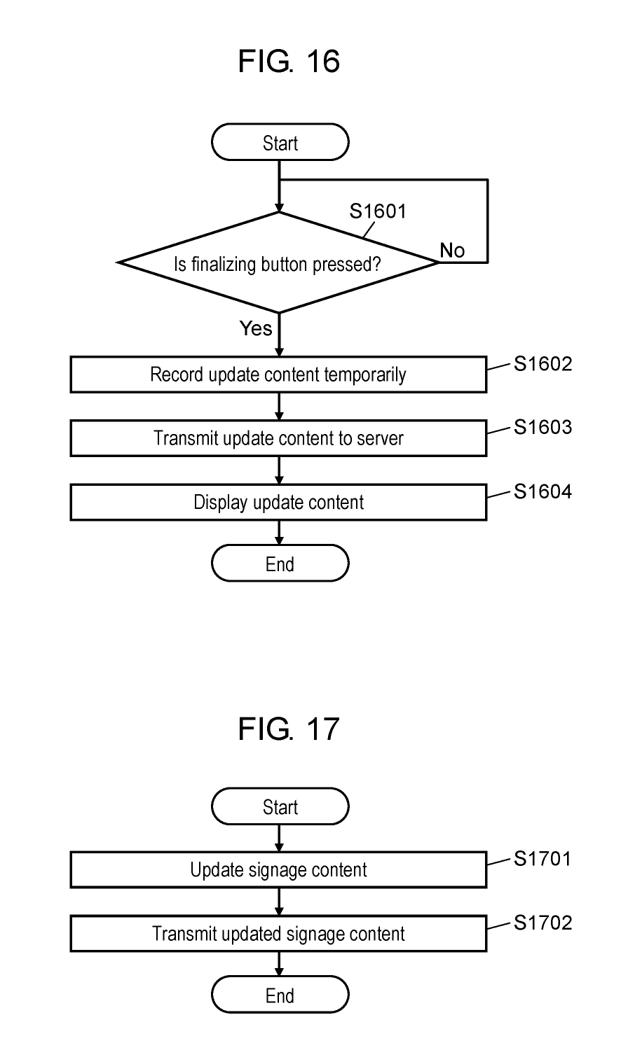

FIG. 16 is a detailed flowchart for S1204 in FIG. 12.

(S1601) Editing unit 122 determines whether or not the user has pressed finalizing button 841 in update executing area 840. If it is determined that finalizing button 841 has been pressed (Yes), the process moves to S1602. If it is determined that finalizing button 841 has not been pressed (No), the process returns to S1601.

(S1602) Editing unit 122 temporarily stores a content updated in signage content display area 810.

(S1603) Editing unit 122 supplies the update content to communication unit 125. Communication unit 125 transmits the update content to communication unit 131 of server 130.

Communication unit 125 receives signage content 200 that has been updated from communication unit 131 of server 130, and supplies to generator 124. Generator 124 generates control screen 800 for signage content 200 that has been updated, and supplies control screen 800 that has been generated to display unit 121. Display unit 121 displays control screen 800 that has been up dated.

FIG. 17 is a flowchart for update of a signage content in server 130 according to the first exemplary embodiment.

(S1701) Upon transmission of the update content for the signage content from communication unit 125 of input device 120 to communication unit 131 of server 130, communication unit 131 of server 130 supplies the update content to update unit 133. Update unit 133 updates the corresponding signage content recorded in recorder 132 based on the update content.

(S1702) Recorder 132 supplies the updated signage content to communication unit 131. Communication unit 131 transmits the updated signage content to communication unit 125 of input device 120.

If the update of the signage content is failed, update unit 133 stops the update, and transmits information that the update has been failed to communication unit 125 of input device 120 via communication unit 131.

### 1-5. Signage Content (2)

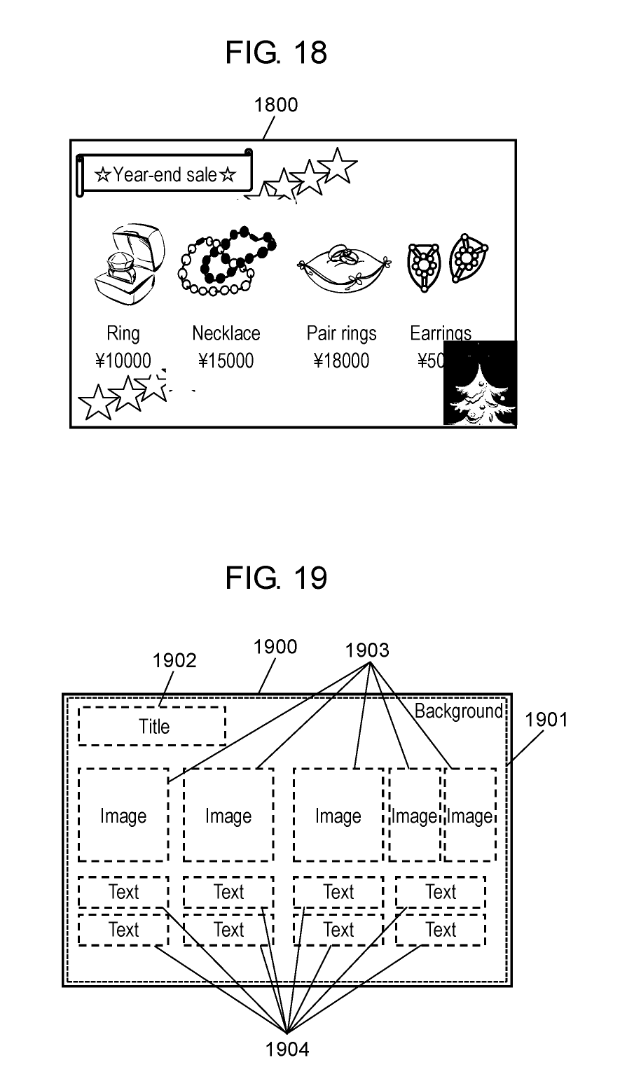

Next, another example of the signage content will be described in detail. FIG. 18 is a diagram illustrating another example of the signage content according to the first exemplary embodiment. With reference to FIG. 18, signage content 1800 is a signage content for a jewelry store, and stars and a tree for Christmas are designed on the background. A message “Year-End Sale” is shown at an upper left position. In a center, four sets of an image, a commercial product name, and a price of jewelry are shown. Signage content 1800 is generated based on a previously prepared template. A displayed content of signage content 1800 is the same as the content of signage content 200 described with reference to FIG. 2, but a template of signage content 1800 is different from the template of signage content 200.

FIG. 19 is a diagram illustrating another example of the template for the signage content according to the first exemplary embodiment. In FIG. 19, template 1900 contains components including background 1901, title 1902, images 1903, and texts 1904. Each of the components defines a display area, a data format, and the like of the component when the component is displayed in display device 110. A background design may be provided on background 1901. As title 1902, a title and a title design of the signage such as “Year-End Sale” or “Today's Special” may be disposed. As images 1903, image data of the commercial products may be disposed. As texts 1904, names and prices of the commercial products may be disposed. Template 1900 in FIG. 19 is different from template 300 of FIG. 3 in that template 1900 includes five images 1903 and eight texts 1904 while template 300 includes four images 303 and four texts 304.

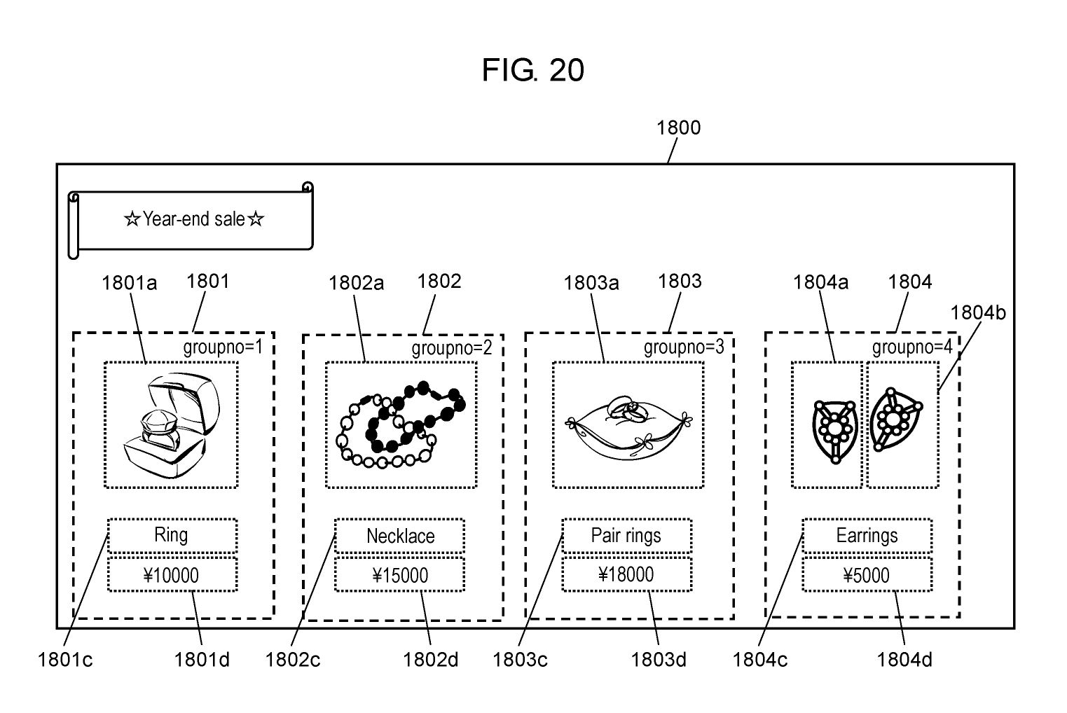

Signage content 1800 is configured such that components contained in signage content 1800 are grouped. FIG. 20 is a diagram illustrating grouping of components in signage content 1800 in FIG. 18. With reference to FIG. 20, images 1903 and texts 1904 in template 1900 in FIG. 19 are grouped for each commercial product. Specifically, signage content 1800 contains groups 1801, 1802, 1803, 1804. Group 1801 contains image 1801a and texts 1801c, 1801d, and is represented by group number (groupno) 1. Group 1802 contains image 1802a and texts 1802c, 1802d, and is represented by group number 2. Group 1803 contains image 1803a and texts 1803c, 1803d, and is represented by group number 3. Group 1804 contains images 1804a, 1804b and texts 1804c, 1804d, and is represented by group number 4. Groups 1801, 1802, 1803, 1804 are a unit for updating contents of signage content 1800. The groups are set so that image 1802a and texts 1802c, 1802d are changed at the same time when the commercial product for group 1802 is to be changed, for example.

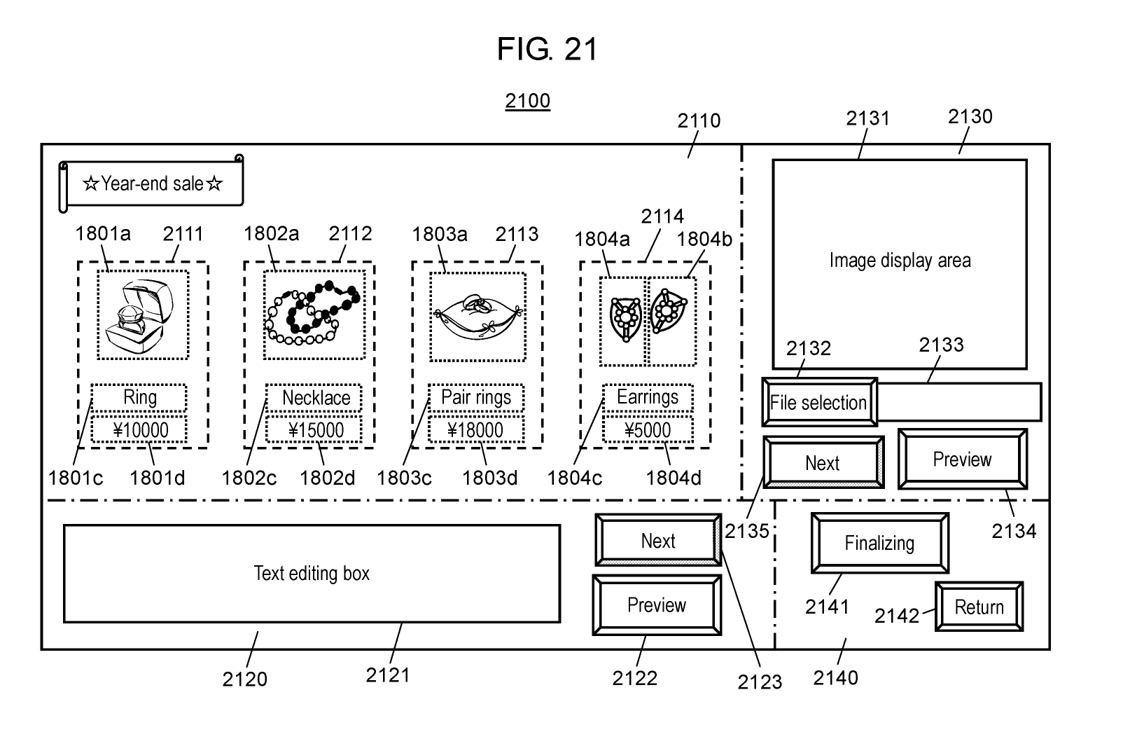

FIG. 21 is a diagram illustrating one example of a control screen for signage content 1800 in FIG. 18 displayed in display unit 121 of input device 120 according to the first exemplary embodiment. With reference to FIG. 21, control screen 2100 includes signage content display area 2110, text update area 2120, image update area 2130, and update executing area 2140.

In signage content display area 2110, a signage content to be updated is displayed. In FIG. 21, signage content 1800 in FIG. 20 is displayed. Signage content 1800 in signage content display area 2110 will be described excluding the background. In signage content display area 2110, rectangular frames in dashed lines are shown respectively for groups defined by signage content 1800. Specifically, group frame 2111 corresponding to group number 1, group frame 2112 corresponding to group number 2, group frame 2113 corresponding to group number 3, and group frame 2114 corresponding to group number 4 are displayed. Selecting any of group frames 2111, 2112, 2113, 2114 enables editing of texts and images included in the selected group frame. The texts are edited in text update area 2120, and the images are edited in image update area 2130.

Text update area 2120 is an area for modifying a content of texts 1801c, 1801d, 1802c, 1802d, 1803c, 1803d, 1804c, 1804d in signage content 1800. Text update area 2120 includes text editing box 2121, preview button 2122, and next button 2123. Text editing box 2121 is a widget for inputting a content to be modified in the text which the user wishes to change. Preview button 2122 is a button widget for showing the content input in text editing box 2121 in signage content display area 2110 for confirmation. Next button 2123 is a button for switching between texts to be edited in text editing box 2121, for example, when text 1804c and text 1804d are contained in group frame 2114, and text 1804c and text 1804d are edited separately. Next button 2123 takes a toggle structure, and text 1804c and text 1804d may be edited alternately by pressing next button 2123.

Image update area 2130 is an area for updating a content of images 1801a, 1802a, 1803a, 1804a, 1804b in signage content 1800. Image update area 2130 includes image display area 2131, file selection button 2132, text box 2133, preview button 2134, and next button 2135. File selection button 2132 is a widget for selecting a file by pressing a button, and clicking this button shows a file selection dialogue. Further, by selecting an arbitrary file through the dialogue, a name of the selected file is displayed in text box 2133. Text box 2133 enables selection of a location at which data for an image desired to be displayed is stored by inputting characters for the location at which data for an image desired to be displayed is stored or by clicking file selection button 2132. In image display area 2131, an image indicated in text box 2133 is displayed. Preview button 2134 is a button widget for showing the image indicated in text box 2133 in signage content display area 2110 for confirmation. Next button 2135 is a button for switching between images to be edited in image display area 2131 and text box 2133, for example, when image 1804a and image 1804b are contained in group frame 2114, and image 1804a and image 1804b are edited separately. Next button 2135 takes a toggle structure, and image 1804a and image 1804b may be edited alternately by pressing next button 2135.

Update executing area 2140 is an area for transmitting the content updated in text update area 2120 and in image update area 2130 to server 130, and for updating signage content 1800 recorded in recorder 132 of server 130. Update executing area 2140 includes finalizing button 2141 and return button 2142. By pressing finalizing button 2141, the content updated in text update area 2120 and image update area 2130 is supplied to communication unit 125. By pressing return button 2142, an application screen before the display shifts to control screen 2100 is resumed.

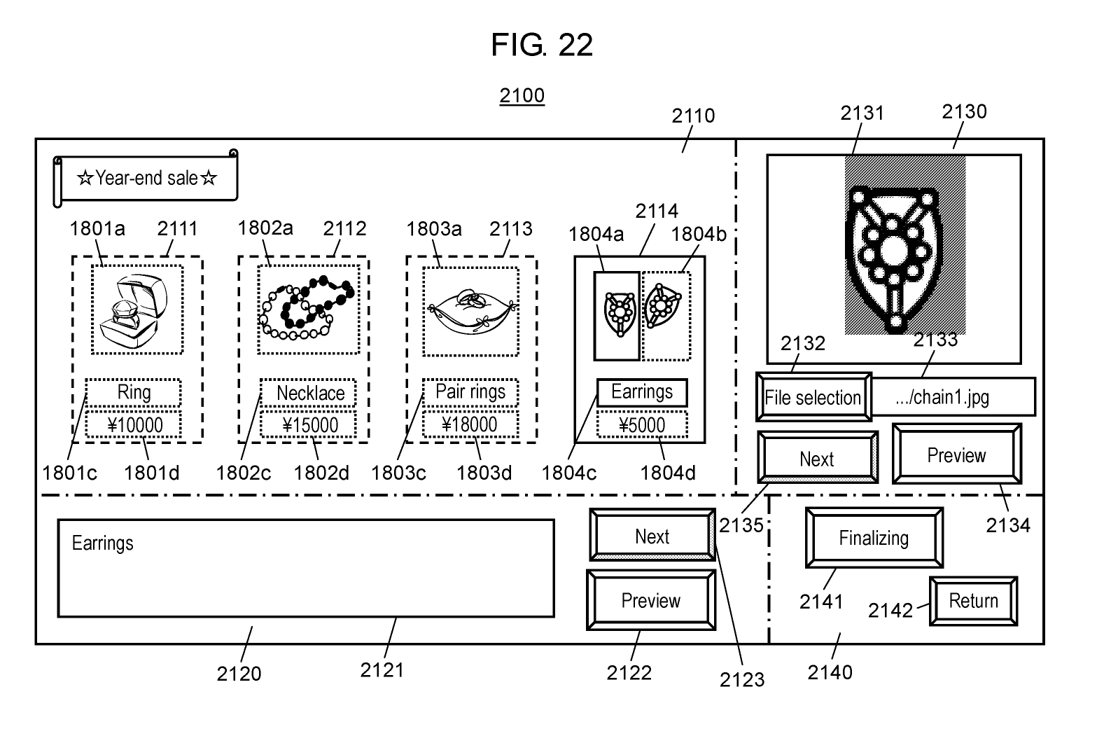

FIG. 22 is a diagram illustrating control screen 2100 when a position within group frame 2114 in signage content display area 2110 in control screen 2100 in FIG. 21 is pressed. When the position within group frame 2114 is pressed in signage content display area 2110 in FIG. 21, representation of group frame 2114 changes from a dashed line to a solid line, and from black to red. In addition, lines for frames of representation of image 1804a and text 1804c also change from dashed lines to solid lines, and from black to red. Further, “earrings” as text 1804c is displayed in text editing box 2121 in text update area 2120. An image for image 1804a is displayed in image display area 2131 in image update area 2130, and “ . . . /chain1.jpg” as a location at which image 1804a is temporarily recorded is displayed in text box 2133.

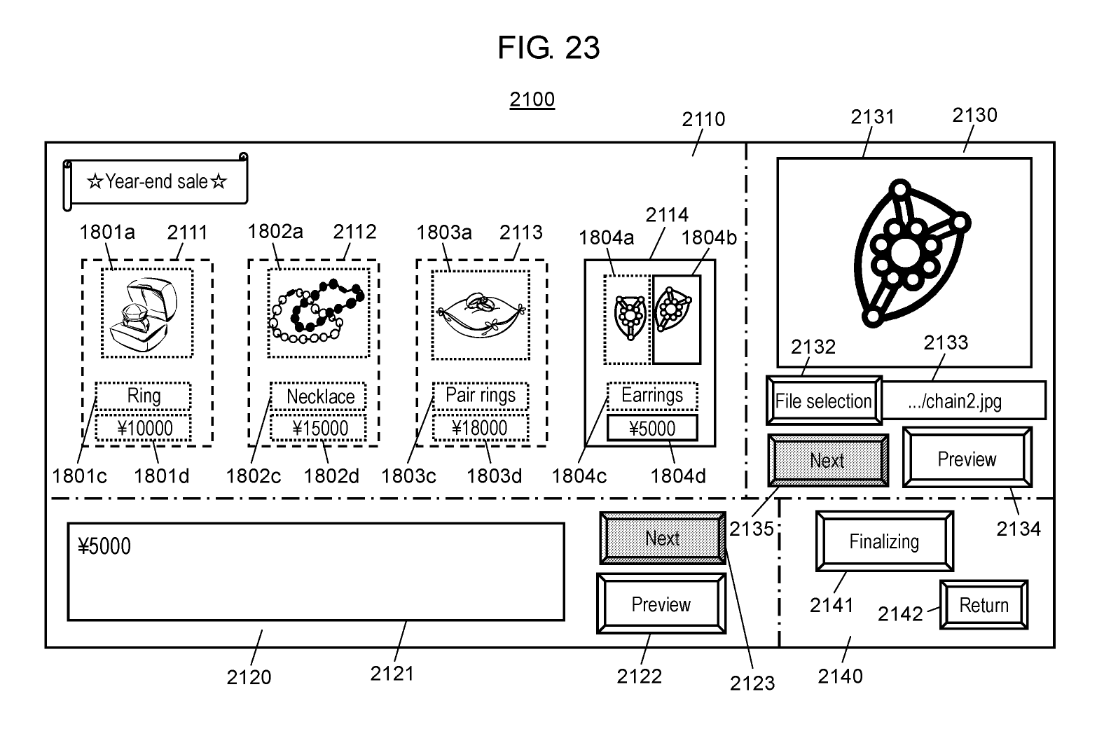

FIG. 23 is a diagram illustrating control screen 2100 when next button 2123 in text update area 2120 and next button 2135 in image update area 2130 in control screen 2100 in FIG. 22 are pressed. Lines for frames of representation of image 1804a and text 1804c in signage content display area 2110 change from solid lines to dashed lines, and from red to black, and lines for frames of representation of image 1804b and text 1804d change from dashed lines to solid lines, and from black to red. Further, “¥5000” (5000 yen) as text 1804d is displayed in text editing box 2121 in text update area 2120. An image for image 1804b is displayed in image display area 2131 in image update area 2130. In text box 2133, “ . . . /chain2.jpg” as a location at which image 1804b is temporarily recorded is displayed.

### 1-6. Signage Content (3)

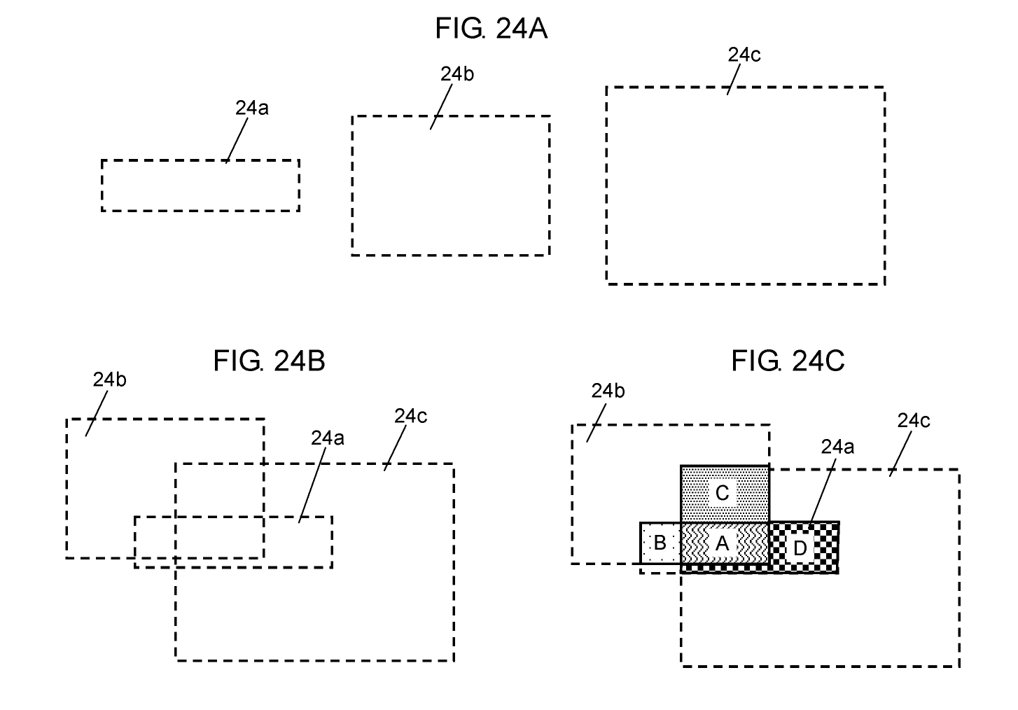

Next, selection of group frames in a case in which a plurality of group frames are overlappingly displayed when a control screen is displayed in display unit 121 of input device 120 will be described. FIG. 24A is a diagram illustrating one example of a plurality of group frames of the signage content, FIG. 24B is a diagram illustrating one example of positions of the plurality of group frames in FIG. 24A on the control screen, and FIG. 24C is a diagram illustrating selection of the group frames at overlapping positions in FIG. 24B where the plurality of group frames overlap. In FIG. 24A, there are three group frames, respectively indicated as group frames 24a, 24b, 24c. Sizes of the group frames are in a relation that group frame 24a<group frame 24b<group frame 24c. Selection of group frames in the case in which group frames 24a, 24b, 24c are overlapping as in FIG. 24B will be described.

With reference to FIG. 24C, group frame 24a is selected if region A where all of group frames 24a, 24b, 24c overlap is pressed, group frame 24a is selected if region B where group frames 24a, 24b overlap is pressed, group frame 24b is selected if region C where group frames 24b, 24c overlap is pressed, and group frame 24a is selected if region D where group frames 24a, 24c overlap is pressed. Specifically, an order of the group frames in an overlapping region is set such that a group frame with a smaller size becomes higher.

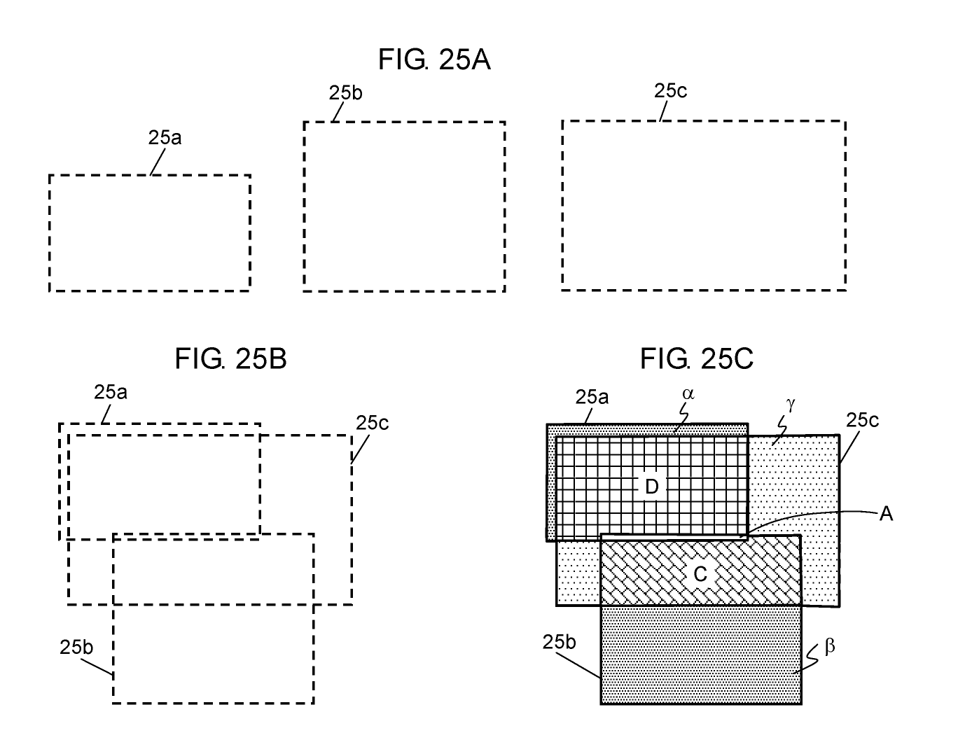

FIG. 25A is a diagram illustrating another example of a plurality of group frames of the signage content, FIG. 25B is a diagram illustrating one example of positions of the plurality of group frames in FIG. 25A on the control screen, and FIG. 25C is a diagram illustrating selection of the group frames at overlapping positions in FIG. 25B where the group frames overlap. In FIG. 25A, there are three group frames, respectively indicated as group frames 25a, 25b, 25c. Sizes of the group frames are in a relation that group frame 25a<group frame 25b<group frame 25c. Selection of group frames in the case in which group frames 25a, 25b, 25c are overlapping as in FIG. 25B will be described.

With reference to FIG. 25C, group frame 25a is selected if region A where all of group frames 25a, 25b, 25c overlap is pressed, group frame 25c is selected if region C where group frames 25b, 25c overlap is pressed, and group frame 25a is selected if region D where group frames 25a, 25c overlap is pressed.

Sizes of regions where group frames do not overlap are compared. Specifically, region α for group frame 25a, region β for group frame 25b, and region γ for group frame 25c are compared. The sizes are such that region α<region γ<region β. An order of the group frames in a region where the group frames do not overlap is set such that a group frame with a smaller size becomes higher.

This is effective and advantageous when sizes of a plurality of group frames that are overlapping are close, or when a proportion of a size of an overlapping region is large relative to a size of the group frame.

### 1-7. Signage Content (4)

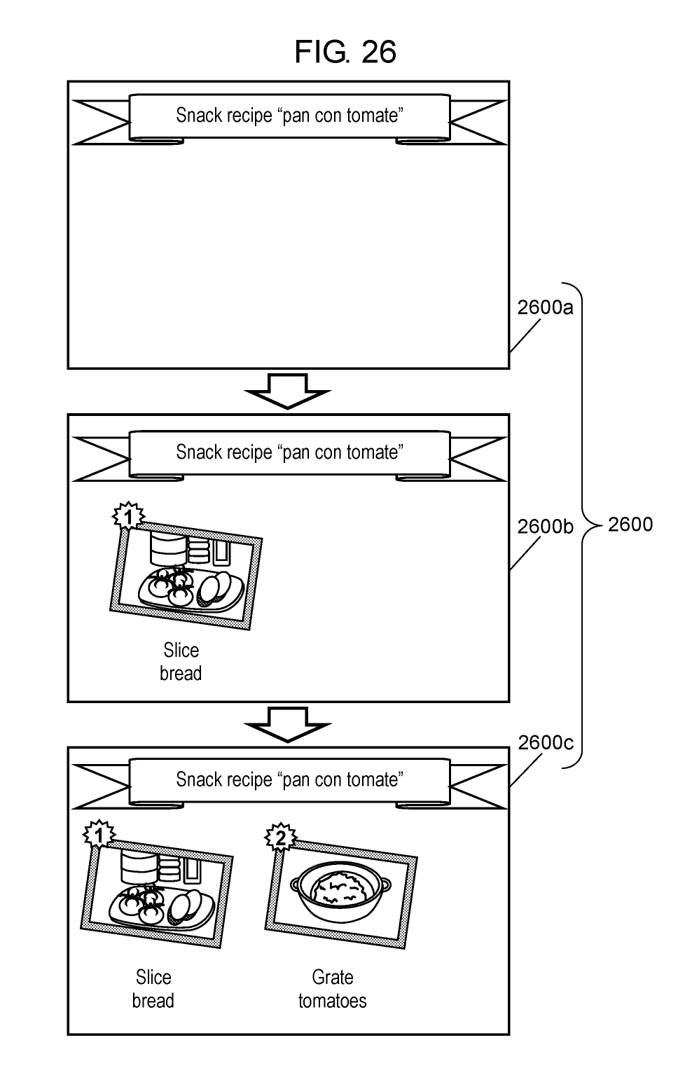

Next, further another example of the signage content will be described in detail. FIG. 26 is a diagram illustrating further another example of the signage content according to the first exemplary embodiment. With reference to FIG. 26, signage content 2600 is a signage content for presenting a recipe for bread by a bread manufacturer, and of a slide show type in which images are sequentially displayed. Signage content 2600 is configured by slide shows 2600a, 2600b, 2600c. There is an indication of “Snack Recipe “Pan Con Tomate”” at a top. It is configured such that two sets of an image of a process number, an image corresponding to the process number, and a text of explanation corresponding to the process number are displayed. Signage content 2600 is generated based on a previously prepared template.

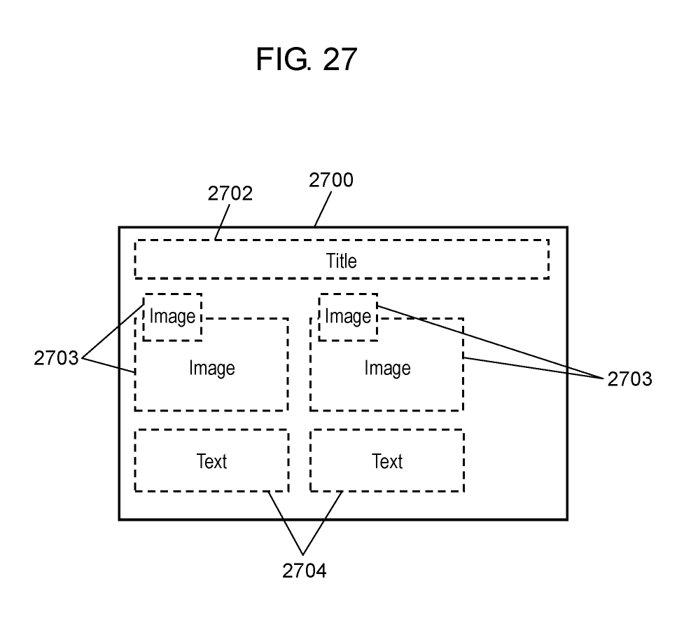

FIG. 27 is a diagram illustrating further another example of the template for the signage content according to the first exemplary embodiment. With reference to FIG. 27, template 2700 contains components including title 2702, images 2703, and texts 2704. Each of the components defines a display area, a data format, and the like of the component when the component is displayed in display device 110. As title 2702, a title and a title design of the signage such as “Recipe of Recommendation” or “Today's Bread Recipe” may be disposed. As images 2703, image data of process numbers or image data corresponding to the process number may be disposed. As texts 2704, texts explaining a process of the recipe may be disposed.

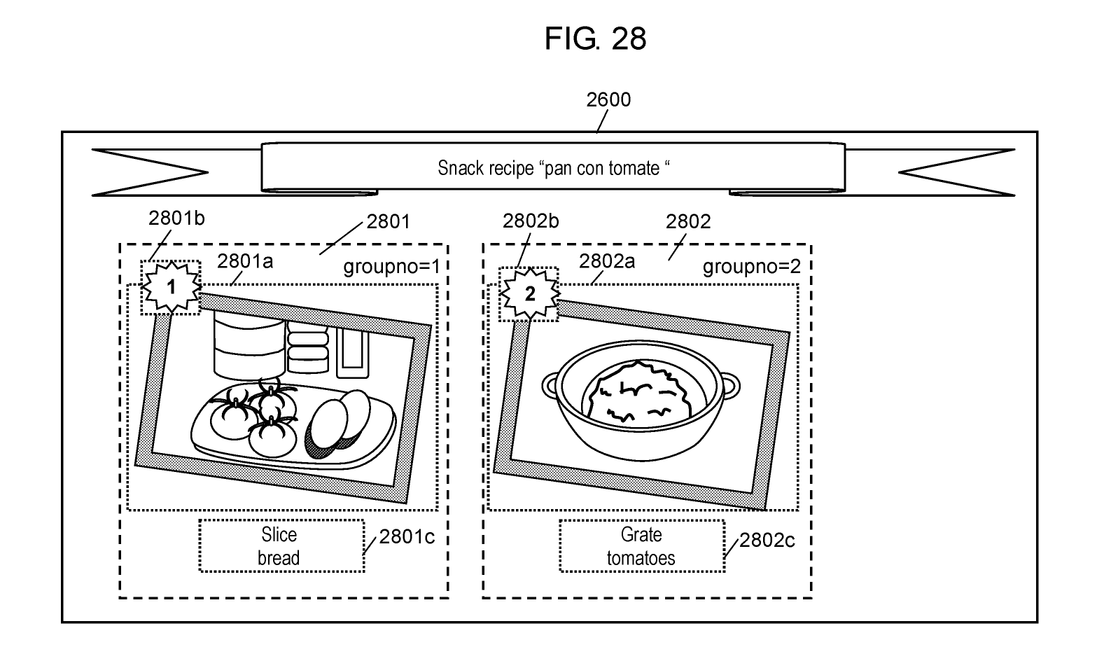

Components contained in signage content 2600 that presents a recipe for bread by a bread manufacturer are grouped. FIG. 28 is a diagram illustrating groups in signage content 2600 in FIG. 26. With reference to FIG. 28, images 2703 and texts 2704 in template 2700 in FIG. 27 are grouped for each of processes. Specifically, signage content 2600 contains groups 2801, 2802. Group 2801 contains images 2801a, 2801b and text 2801c, and is represented by group number (groupno) 1. Group 2802 contains images 2802a, 2802b and text 2802c, and is represented by group number 2. Groups 2801 and 2802 each are a unit for updating signage content 2600. The groups are set so that images 2801a, 2801b and text 2801c are changed at the same time when group 2801 is to be changed, for example.

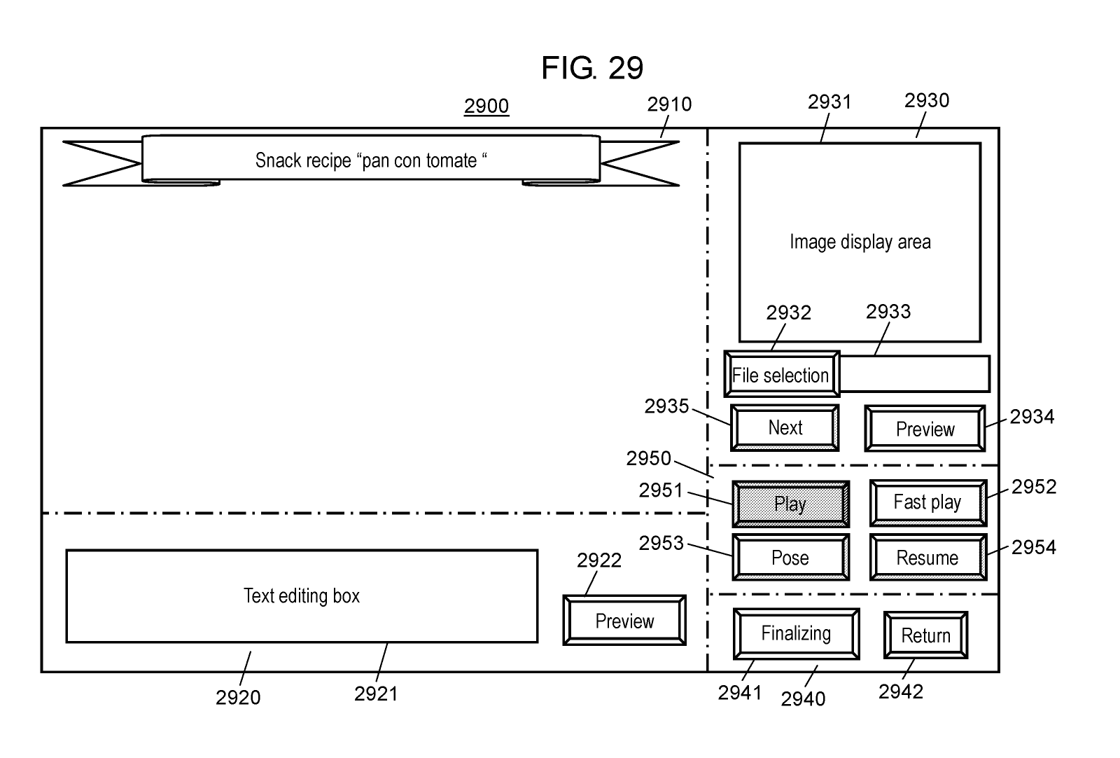

FIG. 29 is a diagram illustrating one example of a control screen for signage content 2600 in FIG. 26 displayed in display unit 121 of input device 120 according to the first exemplary embodiment. FIG. 29 shows control screen 2900 for updating signage content 2600. With reference to FIG. 29, control screen 2900 includes signage content display area 2910, text update area 2920, image update area 2930, update executing area 2940, and playback control area 2950.

In signage content display area 2910, a signage content to be updated is displayed. In FIG. 29, slide show 2600a of signage content 2600 in FIG. 26 is displayed. Text update area 2920 and image update area 2930 will be described later. Playback control area 2950 displays a slide show of signage content 2600. Playback control area 2950 includes playback button 2951, fast-forward playback button 2952, pose button 2953, and resume button 2954. Playback button 2951 is a button for starting display of the slide show of signage content 2600. Fast-forward playback button 2952 is a button for starting display of the slide show of signage content 2600 in a fast-forwarding manner. Pose button 2953 is a button for temporarily stopping display of the slide show of signage content 2600. Resume button 2954 is a button for resuming display of the slide show of signage content 2600 that is temporarily stopped. In FIG. 29, playback button 2951 is pressed. Upon pressing of playback button 2951, display of the slide show of signage content 2600 in signage content display area 2910 is started.

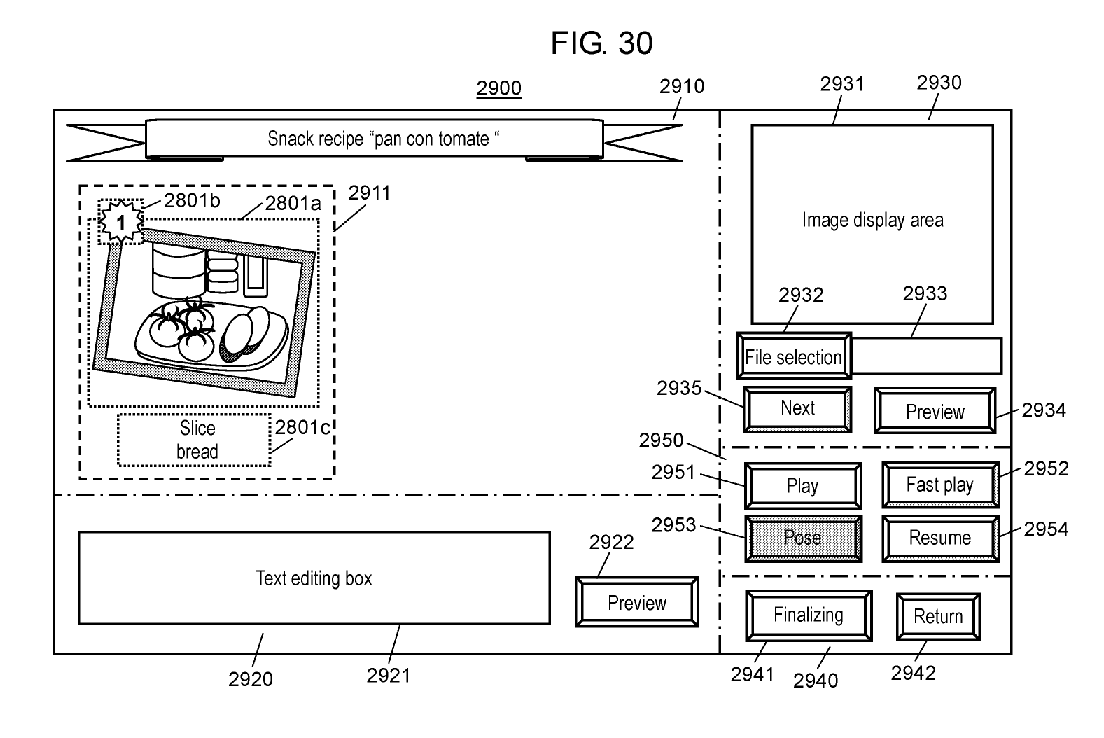

FIG. 30 is a diagram illustrating control screen 2900 when playback in signage content display area 2910 in control screen 2900 in FIG. 29 is started and then posed. In FIG. 29, playback button 2951 is pressed, and in FIG. 30, slide show 2600b of signage content 2600 in FIG. 26 is displayed in signage content display area 2910. In FIG. 30, pose button 2953 is pressed. Upon pressing of pose button 2953, display of the slide show of signage content 2600 in signage content display area 2910 is stopped. In slide show 2600b of signage content 2600 in signage content display area 2910, rectangular frames in dashed lines are displayed respectively for groups that are defined. Specifically, group frame 2911 corresponding to group number 1 is displayed. Selecting group frame 2911 enables editing of texts and images that belong to a group corresponding to the selected group frame. The texts are edited in text update area 2920, and the images are edited in image update area 2930.

Text update area 2920 is an area for modifying a content of text 2801c of slide show 2600b of signage content 2600. Text update area 2920 includes text editing box 2921 and preview button 2922. Text editing box 2921 is a widget for inputting a content to be modified in the text to which the user wishes to change. Preview button 2922 is a button widget for showing the content input in text editing box 2921 in signage content display area 2910 for confirmation.

Image update area 2930 is an area for modifying a content of images 2801a, 2801b in slide show 2600b of signage content 2600. Image update area 2930 includes image display area 2931, file selection button 2932, text box 2933, preview button 2934, and next button 2935. File selection button 2932 is a widget for selecting a file by pressing a button, and clicking this button shows a file selection dialogue. Then, by selecting an arbitrary file through the dialogue, a name of the selected file is displayed in text box 2933. Text box 2933 enables selection at which a location of data for an image desired to be displayed is stored by inputting characters for the location at which data for an image desired to be displayed is stored or by clicking file selection button 2932. In image display area 2931, an image indicated in text box 2933 is displayed. Preview button 2934 is a button widget for showing the image indicated in text box 2933 in signage content display area 2910 for confirmation. Next button 2935 is a button for switching between images to be edited in image display area 2931 and text box 2933, for example, when image 2801a and image 2801b are contained in group frame 2911, and image 2801a and image 2801b are edited separately. Next button 2935 takes a toggle structure, and image 2801a and image 2801b may be edited alternately by pressing next button 2935.

Update executing area 2940 is an area for transmitting the content updated in text update area 2920 and in image update area 2930 to server 130, and for updating signage content 2600 recorded in recorder 132 of server 130. Update executing area 2940 includes finalizing button 2941 and return button 2942. By pressing finalizing button 2941, the content updated in text update area 2920 and image update area 2930 is supplied to communication unit 125. By pressing return button 2942, an application screen before the display shifts to control screen 2900 is resumed.

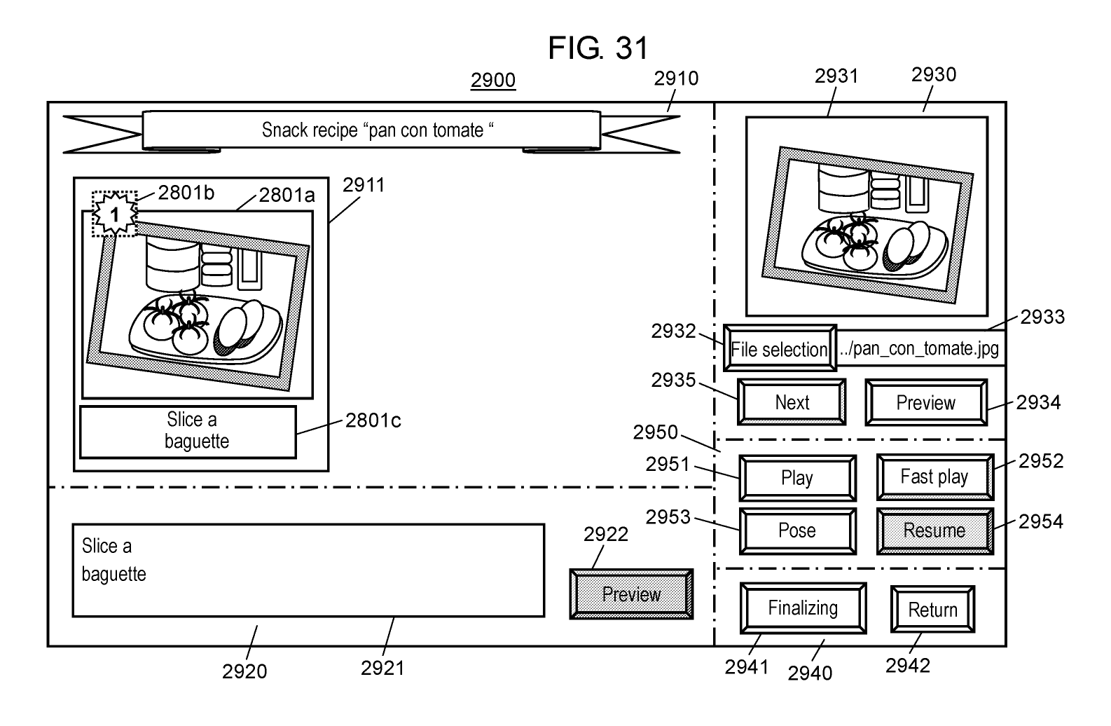

FIG. 31 is a diagram illustrating control screen 2900 when a position within a group frame in signage content display area 2910 in control screen 2900 in FIG. 30 is pressed. With reference to FIG. 31, slide show 2600b of signage content 2600 in FIG. 26 is displayed in signage content display area 2910. When the position within group frame 2911 is pressed in signage content display area 2910 in FIG. 31, representation of group frame 2911 changes from a dashed line to a solid line, and from black to red. In addition, lines for frames of representation of image 2801a and text 2801c also change from dashed lines to solid lines, and from black to red. A content may be updated in text update area 2920 and image update area 2930. An update content for text 2801c “Slice a baguette” is input in text editing box 2921 in text update area 2920, preview button 2922 is pressed, and the update content for text 2801c in signage content display area 2910 may be confirmed. In image display area 2931 in image update area 2930, an image of image 2801a is displayed. In text box 2933, “ . . . /pan_con_tomate.jpg” as a location at which image 2801a is temporarily recorded is displayed. Upon pressing of resume button 2954 in FIG. 31, display of the slide show of signage content 2600 is resumed.

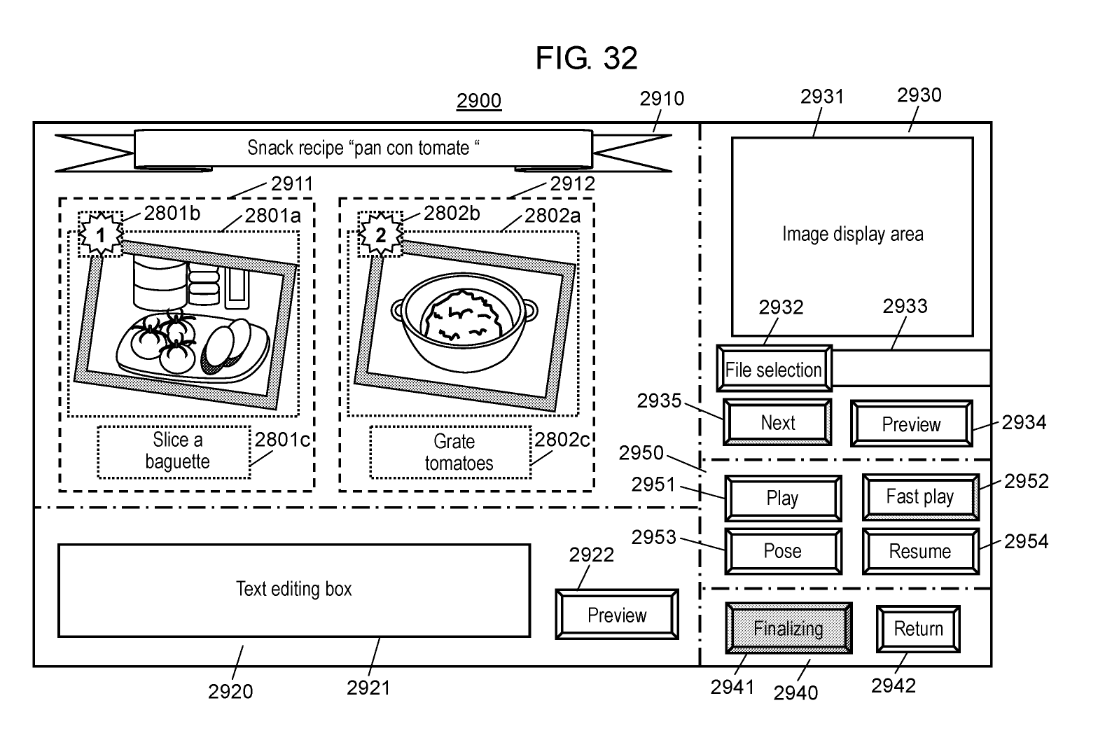

FIG. 32 is a diagram illustrating control screen 2900 when playback of signage content display area 2910 in control screen 2900 in FIG. 31 is resumed, and then signage content 2600 is updated. With reference to FIG. 32, slide show 2600c of signage content 2600 in FIG. 26 is displayed in signage content display area 2910. Specifically, group frame 2912 is newly displayed in signage content display area 2910. Upon completion of update of signage content 2600, finalizing button 2941 is pressed.

### 1-8. Effects

As described above, the signage system of this exemplary embodiment may present a control screen to a user according to a display content of a signage content, and it is possible to update the signage content by grouping a content for a commercial product and the like.

### Second Exemplary Embodiment

Hereinafter, a signage system according to a second exemplary embodiment will be described. In this exemplary embodiment, the description mainly focuses on differences from the first exemplary embodiment, and similarities shall be omitted. The signage system according to this exemplary embodiment is to display a control screen by switching between control screens based on identification information. The description is given taking signage content 1800 described with reference to FIG. 18.

### 2-1. Configuration of Signage System

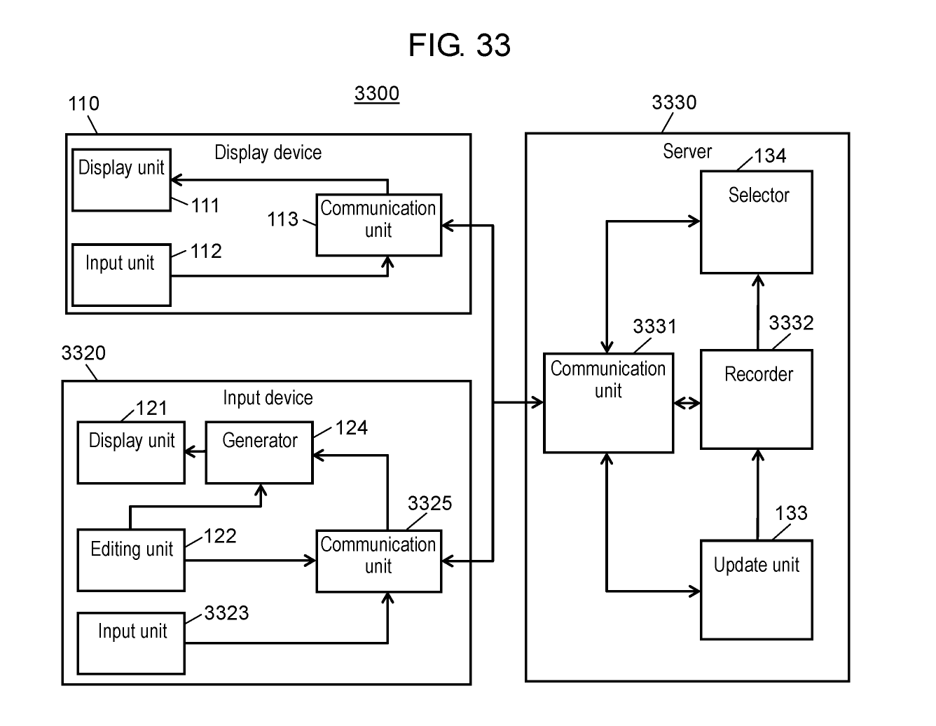

FIG. 33 is a detailed block diagram illustrating signage system 3300 according to the second exemplary embodiment. Signage system 3300 is configured by display device 110 that displays a signage content, input device 3320 that inputs an update content of the signage content, and server 3330 that manages the signage content. Display device 110 and server 3330, and input device 3320 and server 3330 are connected via a network, respectively. Communication between display device 110 and server 3330, and communication between input device 3320 and server 3330 may employ a secure communication system to prevent spoofing and such. Further, communication between input device 3320 and server 3330 may be performed using, as identification information, a user ID for identifying a user or a terminal ID for identifying input device 3320. Examples of the terminal ID include an IP address, MAC address, and identification information unique to a device. In this exemplary embodiment, the description is given taking the user ID.

Input device 3320 includes display unit 121, editing unit 122, input unit 3323, generator 124, and communication unit 3325. Server 3330 includes communication unit 3331, recorder 3332, update unit 133, and selector 134.

Recorder 3332 of server 3330 records association between the user ID and a signage content, such that a portion that may be updated in the signage content is switched for each user ID. For example, an updatable group number and an updatable text in the signage content is associated with each user ID.

When communication between input device 3320 and server 3330 is started, the user ID is used. The user ID is input through input unit 3323 of input device 3320, and supplied to communication unit 3325. Communication unit 3325 transmits the user ID to communication unit 3331 of server 3330. Communication unit 3331 that has received the user ID records the user ID in recorder 3332.

On a side of input device 3320, an update request for a signage content is input through input unit 3323, and supplied to communication unit 125. Upon reception of the update request, communication unit 3325 transmits the update request to communication unit 3331 of server 3330. Upon reception of a signage content for which update is requested from communication unit 3331 of server 3330, communication unit 3325 supplies the signage content to generator 124. Here, as the signage content received from communication unit 3331 of server 3330, a signage content corresponding to a user ID of a user is transmitted. Specifically, a portion that may be updated in the transmitted signage content is different according to the user ID.

On a side of server 3330, recorder 3332 records signage contents in association with user IDs. Upon reception of an update request from communication unit 3325 of input device 3320, communication unit 3331 supplies the update request to selector 134. Selector 134 reads, from recorder 3332, a signage content associated with the user ID recorded when communication with input device 3320 starts, and supplies this signage content to communication unit 3331. Communication unit 3331 transmits the read signage content to communication unit 3325 of input device 3320.

### 2-2. Control Screen

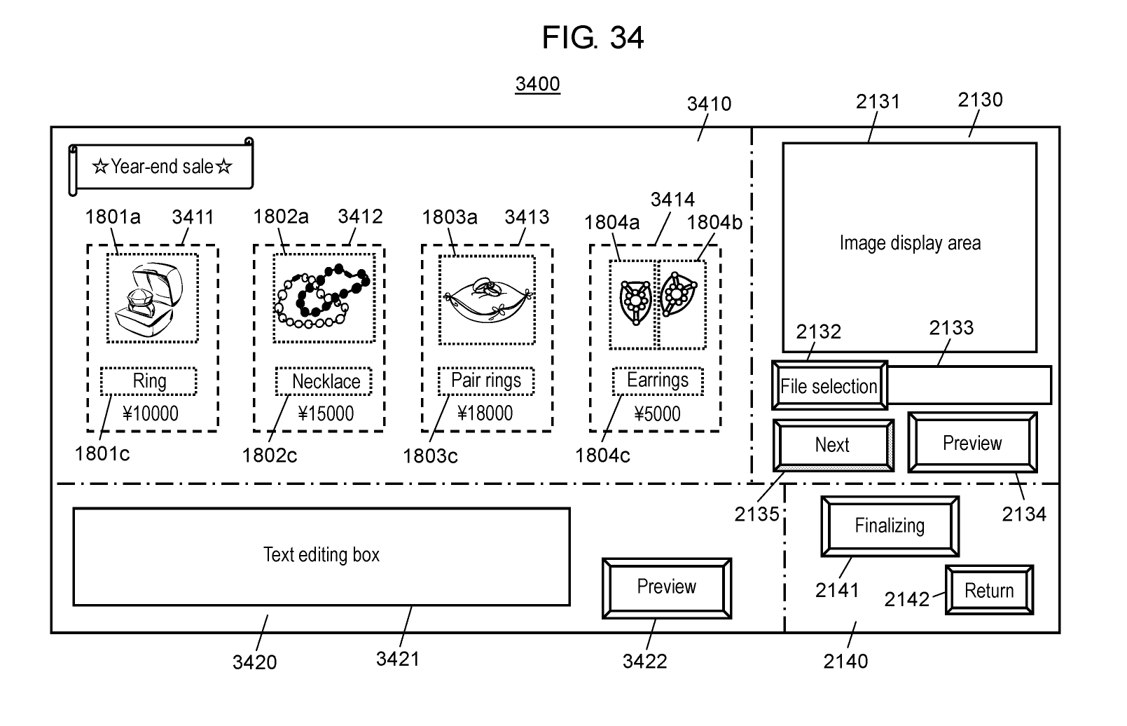

Next, a control screen of signage content 1800 described with reference to FIG. 18 will be described. In this exemplary embodiment, an item that may be updated is different for each user ID even with the same signage content. FIG. 34 shows one example of a control screen according to this exemplary embodiment. With reference to FIG. 34, control screen 3400 includes signage content display area 3410, text update area 3420, image update area 2130, and update executing area 2140.

In signage content display area 3410, a signage content to be updated is displayed. In FIG. 34, signage content 1800 in FIG. 18 is displayed. Signage content 1800 in signage content display area 3410 will be described excluding a background. In signage content display area 3410, group frame 3411 corresponding to group number 1, group frame 3412 corresponding to group number 2, group frame 3413 corresponding to group number 3, and group frame 3414 corresponding to group number 4 are displayed. Selecting any of group frames 3411, 3412, 3413, 3414 enables editing of texts and images included in the selected group frame. The texts are edited in text update area 3420, and the images are edited in image update area 2130.

Text update area 3420 is an area for modifying a content of texts 1801c, 1802c, 1803c, 1804c in signage content 1800. Text update area 3420 includes text editing box 3421 and preview button 3422. Text editing box 3421 is a widget for inputting a content to be modified in the text to which the user wishes to change. Preview button 3422 is a button widget for showing the content input in text editing box 3421 in signage content display area 3410 for confirmation.

Control screen 3400 in FIG. 34 is different from control screen 2100 in FIG. 21 in that texts 1801d, 1802d, 1803d, 1804d are not contained in group frames 3411, 3412, 3413, 3414 in signage content 1800, and may not be up dated.

It is assumed that on a side of recorder 3332 of server 3330, signage content 1800 is associated with user ID “USER1” so as to make all of images and texts contained in the groups updatable, signage content 1800 is associated with user ID “USER2” so as not to make texts 1801d, 1802d, 1803d, 1804d contained in the groups updatable. When user ID “USER1” makes an update request for signage content 1800, control screen 2100 described with reference to FIG. 21 according to the first exemplary embodiment is displayed. When user ID “USER2” makes an update request for signage content 1800, control screen 3400 in FIG. 34 is displayed.

In this manner, by identifying the user ID, the terminal ID, and the like, the user who operates input device 3320 is identified and components that may be updated by the user may be set. With this, it is possible to set authority for update individually in detail.

Further, another control screen for signage content 1800 described with reference to FIG. 18 will be described. In this exemplary embodiment, a case in which as the item that may be updated for each user ID, the group that may be updated is different for each user ID even with the same signage content will be described.

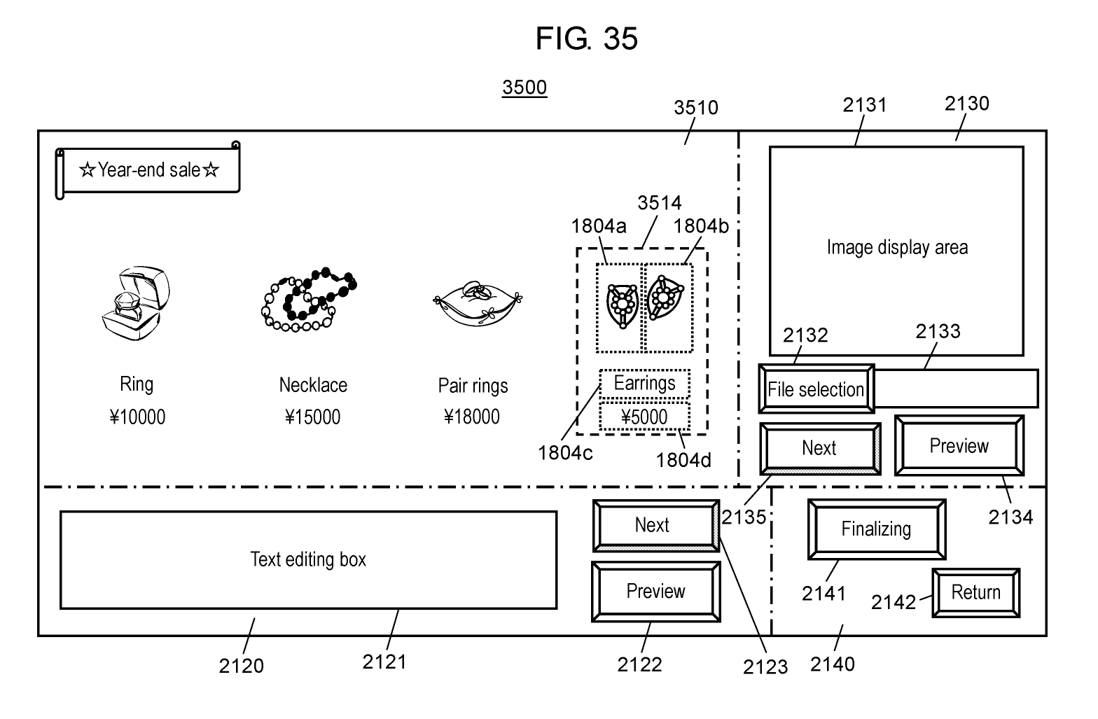

FIG. 35 shows another example of a control screen according to this exemplary embodiment. With reference to FIG. 35, control screen 3500 includes signage content display area 3510, text update area 2120, image update area 2130, and update executing area 2140.

In signage content display area 3510, a signage content to be updated is displayed. In FIG. 35, signage content 1800 in FIG. 18 is displayed. Signage content 1800 in signage content display area 3510 will be described excluding a background. In signage content display area 3510, only group frame 3514 corresponding to group number 4 is displayed. Selecting group frame 3514 enables editing of texts and images included in the selected group frame. The texts are edited in text update area 2120, and the images are edited in image update area 2130.

Control screen 3500 in FIG. 35 is different from control screen 2100 in FIG. 21 in that only group frame 3514 in signage content 1800 may be updated.

It is assumed that on a side of recorder 3332 of server 3330, an updatable group in signage content 1800 is associated with user ID “USER3”. When user ID “USER3” makes an update request for signage content 1800, control screen 3500 in FIG. 35 is displayed.

In this manner, by identifying the user ID, the terminal ID, and the like, the user who operates input device 3320 is identified and components that may be updated by the user may be set. With this, it is possible to set update authority individually for user IDs and terminal IDs, to set different levels of update authority even in the same store, and to set different levels of update authority for different stores.

While it is described that signage content 1800 transmitted from server 3330 is different according to the user ID in this exemplary embodiment, the present disclosure is not limited to such an example. For example, signage content 1800 transmitted from server 3330 may be the same, and a list of components that may be updated using users ID may be transmitted at the same time as the transmission of the content, and a control screen to be generated by generator 124 of input device 3320 may be switched.

### 2-3. Effects

As described above, the signage system of this exemplary embodiment may present a control screen for update according to a display content of a signage content, and it is possible to update the signage content by grouping a content for a commercial product and the like.

Further, it is possible to easily change levels of update authority for updating identical signage content respectively for users and terminals.

### Other Exemplary Embodiments

As described above, the first and the second exemplary embodiments are described in the present disclosure. However, the present disclosure is not limited to the above description, and may also be applied to exemplary embodiments with modification, replacement, addition, and/or omission. Further, it is possible to provide a new exemplary embodiment by combining the components described in the first and the second exemplary embodiments.

Therefore, other exemplary embodiments are described as examples in the following.

(1) While the control screen is generated by the input device in the above exemplary embodiments, the control screen may be generated by the server.

(2) While the images and the texts are used as the components of the signage content in the description of the above exemplary embodiments, the present disclosure is not limited to such an example. For example, components such as sound, music, and video may be used.

(3) In the description of the above exemplary embodiments, “groupno”, “editableimage”, and “editabletext” are used as descriptions of tag attributes. However, the present disclosure is not limited to such an example. When video is used as a component of the signage content, attributes “groupno” and “editablevideo” that should be added to a video tag element may be used. Further, the control screen may be generated based on img, text, video, and groupno as names for tag types without using attributes “editableimage”, “editabletext”, and “editablevideo”.

(5) While it is described that the user ID or the terminal ID is used for identification in the above exemplary embodiments, both of the user ID and the terminal ID may be used for identification.

(6) While it is described that grouping of the components is performed on a side of the signage content in the above exemplary embodiments, the present disclosure is not limited to such an example. The grouping may be performed on a side of the template.

The signage system according to the present disclosure may be widely applied to devices having functions for data editing and for data updating.

1. An input device comprising:
a generator configured to generate a control screen for updating a content of a slide show type in which a plurality of images are sequentially displayed, the control screen including a playback button for playback the slide show and a pose button for posing playback of the slide show;
a display unit configured to display the control screen; and
an editing unit configured to edit the content using the control screen,
wherein groups each containing a plurality of components are defined in the content, and
the generator generates, with respect to an image being displayed, a group frame for one of the groups on the control screen when the pose button is pressed after the playback button is pressed, and generates the control screen so as to change the plurality of components when the group frame is selected by the editing unit.

2. The input device according to claim 1, wherein
in the content, the plurality of components each have a description of a first tag attribute for identifying the group, and
the generator generates the control screen so as to change the plurality of components each having the description of the first tag attribute.

3. The input device according to claim 1, wherein
a component that is updatable among the plurality of components of the groups includes a second tag attribute indicating that the component is up datable.

4. The input device according to claim 1, wherein
the generator includes, on the control screen, an update region for updating the plurality of components that belong to the group.

5. The input device according to claim 1, wherein
when the group frame on the control screen is selected by the editing unit, the generator generates the control screen such that the selection of the group frame is highlighted.

6. The input device according to claim 5, wherein
when the group frames overlap, the generator determines, based on overlapping areas, an order of the group frames arranged on the control screen.

7. The input device according to claim 1, further comprising:
an input unit configured to input identification information for identifying one of a user and a device,
wherein a updatable portion of a component among the plurality of components in the content varies based on the identification information, and
the generator generates the control screen based on the identification information.

8. The input device according to claim 1, wherein
the content is managed by a server,
the content is displayed in a display device, and
the input device is connected with the server and the display device via a network.

9. An input program comprising:
a generating step of generating a control screen for updating a content of a slide show type in which a plurality of images are sequentially displayed, the control screen including a playback button for playback the slide show and a pose button for posing playback of the slide show;
a displaying step of displaying the control screen; and
an editing step of editing the content using the control screen,
wherein groups each containing a plurality of components are defined in the content, and
in the generating step, a group frame for one of the groups is generated on the control screen, and the control screen is generated so as to change the plurality of components are changed, when one of the group frames is selected in the editing step.

10. An input method comprising:
a generating step of generating a control screen for updating a content of a slide show type in which a plurality of images are sequentially displayed, the control screen including a playback button for playback the slide show and a pose button for posing playback of the slide show;
a displaying step of displaying the control screen; and
an editing step of editing the content using the control screen,
wherein groups each containing a plurality of components are defined in the content, and
in the generating step, with respect to an image being displayed, a group frame for one of the groups is generated on the control screen when the pose button is pressed after the playback button is pressed, and the control screen is generated so as to change the plurality of components, when one of the group frames is selected in the editing step.
